(19) United States
(12) Patent Application Publication
(10) Pub. No.: US 2008/0228675 A1
(43) Pub. Date: Sep. 18, 2008

(54) MULTI-TIERED CASCADING CRAWLING SYSTEM

(75) Inventors: Paul Duffy, Westlake Village, CA (US); Wojtek Piaseczny, Westlake Village, CA (US); Zhe Zhang, Westlake Village, CA (US); Sean Whitley, Los Angeles, CA (US); Joe DeTuno, Thousand Oaks, CA (US); Matthew Moore, Westlake Village, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Move, Inc.

(21) Appl. No.: 11/872,380

(22) Filed: Oct. 15, 2007

Related U.S. Application Data
(60) Provisional application No. 60/829,453, filed on Oct. 13, 2006.

(51) Int. Cl. G06F 15/18; G06F 17/30; G06F 15/16; G06F 7/00

(52) U.S. Cl. 706/10; 707/5; 709/201; 706/12; 707/E17.108

(57) ABSTRACT

Provided is a multi-tiered cascading crawling system for finding on a network information related to one or more predetermined topics or subtopics of interest. In general, embodiments of the present invention provide a system that operates in multiple “tiers,” where at least some of the output of one tier is used to comprise the input of the next tier. Each tier generally analyzes collections of documents on the network using successively more restrictive criteria about the subject matter of each collection and/or about which collections may be related to the one or more topics or subtopics. In general, only the final tier performs an exhaustive crawl of all of the documents of the collections that are identified by the system as being relevant to the topic or subtopic of interest.

### CROSS REFERENCE TO A RELATED APPLICATION

This application claims the benefit of U.S. Provisional Patent Application No. 60/829,453 filed Oct. 13, 2006, the contents of which are incorporated herein by reference in their entirety.

### FIELD OF THE INVENTION

Embodiments of the present invention relate generally to a system, method, and computer program product for searching for and/or gathering information on a network.

### BACKGROUND OF THE INVENTION

It is estimated that the Internet presently includes over ten billion visible Web pages and possibly even hundreds of billions of pages in the “deep Web” (e.g., information on the Internet not accessible directly by a hyperlink, such as information stored in databases and accessible only by specific query or by submitting information into a form on a web page). As a result, the Internet can be an enormously useful resource for finding information on almost any topic. However, because the Internet is so large and because it is ever changing and growing, there is a need for an efficient system of discovering, classifying, and presenting the information on the Internet so as to allow a user to quickly find specific and up-to-date information related to a particular topic of interest.

### The Internet and the World Wide Web

The Internet is a global computer network where many individual computers and computer networks are linked together over a series of communication networks. Some entities on the network (i. e., “hosts”) allow other computers on the network to access information stored in the host's computer(s) or in some other location that the host computer(s) can access. In this way, a user having a computer connected to the network may be able to retrieve the shared information from the host computer.

The World Wide Web, web browsers, and other systems and protocols have been created to standardize the information on the Internet and the way in which one computer asks for and retrieves the information from another computer. In general, the Internet has systems for identifying a host on the network. For example, each computer (or group of computers) on the Internet may have an IP address (e.g., a numerical identifier) that identifies the computer's location on the network so that information can be transferred to and from that location on the network. Users who wish to share information on the Internet can find and purchase one or more text-based domain names and then register their computer's IP address with the one or more text-based domain names or sub-domain names in a domain name registrar. In this way other Web users can use the text-based domain name to locate and access at least portions of the host computer.

A Uniform Resource Locator (URL) is a standardized system for indicating the domain name or a sub-domain name and for identifying information of interest on the host computer associated with the indicated domain name or sub-domain name. For example, if a Web user desires to go to Move, Inc.'s homepage, the user may be able to do so by typing the URL www.move.com into the user's web browser. The domain name portion (“move.com”), the “host” portion (“www”), and any sub-domain portion of the URL is used to look up the IP address that is registered as corresponding to the indicated host for the particular domain or sub-domain. An HTTP (Hypertext Transfer Protocol) request is sent to the web server on the host computer(s) that corresponds to the IP address. Typically, the server will return documents containing data written in HTML (Hypertext Markup Language) as well as associated files (e.g., image files) to the user's web browser. The HTML file may contain content information, but will also often contain presentation information (e.g., HTML code that indicates to the web browser how the server's information should be presented to the user) as well as behavior information (e.g., instructions that describe how the user can interact with that information or with the web page itself). For example, the HTML files may also include Forms, JavaScript, Applets, Flash, AJAX, DHTML, and the like, that are not content information but allow the user to interact with the page to accomplish some task.

Each IP Address may host many web pages at the same time. The term “website” is used to generally refer to collections of interrelated web pages, such as web pages that share a common domain name and/or are provided by a common host. The different web pages of a website are distinguished by the web page's URL. For example, http://www.move.com may direct a web user to Move Inc.'s homepage, while

http://www.move.com/apartments/westlakevillage_california/ may be a hyperlink on the homepage that directs the user to a web page having information about apartments in Westlake Village, Calif. The two web pages share the same “move.com” domain name and may be hosted by the same server, although the unique URLs indicate separate web pages.

Web pages often contain multi-media elements (such as text, graphics, images, etc.) and also typically contain a plurality of hyperlinks. A hyperlink is some text, icon, image, or other multi-media element on the web page that is associated with another URL. The hyperlink allows the user to click on the linked element so that the user can be redirected to the corresponding URL, which may provide access to another web page from the same website or may be a web page from some other website. In this way, many of the web pages and websites on the Internet are interconnected.

### The Typical Search Engine and Web Crawler

With billions of pages encompassing almost every topic imaginable and with a largely standardized structure for the Web, there is wealth of information available to anyone who can access the Internet. However, in order to effectively use the Internet, one must be able to efficiently find the most relevant web pages from the billions of irrelevant web pages. To solve this problem, search engines have been created to locate and index many of the web pages on the Internet. In this way, a search engine can allow a user to search the index in an attempt to locate the web pages that are most likely to be relevant to the topic that the user is interested in.

A typical search engine begins the search process with a list of seed pages and a “web crawler.” The seed pages are often already-known web pages that contain many hyperlinks that branch out in a wide area over the web. The web crawler is a program that “crawls” around the Web looking for and indexing web pages. FIG. 1 shows the basic structure of a typical web crawling scheme 1100. In the first step 1120, the URLs for the seed pages are stored in a datastore and are used as the starting point for the web crawler. As used herein, the term “datastore” may include any number of options known in the art that allow for management and use of collected information, such as data repositories, databases, and the like, or data stored in file systems, XML, memory BLOBs (Binary Large Objects), and the like. This datastore of unvisited URLs is often referred to as the “frontier.” In the next step 1140 the web crawler selects a URL from the frontier and then, in step 1150, fetches the corresponding web page. Once the web page is downloaded, the web crawler, in step 1160, indexes all of the terms on the web page. While indexing the web page, the web crawler also saves each hyperlink that it finds on the web page and, in step 1170, adds the URL corresponding to each hyperlink to the frontier so that the URL may be used at a later time to request and index the corresponding web page. Once the web crawler finishes indexing the web page, the web crawler returns to step 1130 and, assuming there are URLs remaining in the frontier, continues the process of selecting one of the URLs, fetching the web page, indexing the web page, and adding more URLs to the frontier. Since the Internet is continually changing and expanding, a well designed crawling process may continue this loop indefinitely. Once the web crawler has put together a substantial index, the index is used by the search engine to respond to a web user's search request. The search engine uses keywords entered by the user and searches the index to find URLs stored in the index along with those keywords. The search engine then returns a list of URLs to the user, usually ranked by some measure of relevancy.

### Specific Web Crawling Issues

Step 1140, which involves selecting the next URL from the frontier, can vary depending on the web crawler. Typical methods used for selecting the next URL to index are: (1) “depth-first” method, (2) “breadth-first” method, and (3) “PageRank” method. A depth-first method, also known as a last-in-first-out (LIFO) method, indexes a first web page and then follows a hyperlink discovered in the first web page to a second web page. The crawler then indexes the second web page and, if it discovers hyperlinks on the second web page, it follows one of these hyperlinks to a third web page, indexes the third web page, and follows a link on the third web page to a fourth web page, and so on. In contrast, a breadth-first method, also known as a first-in-first-out (FIFO) method, indexes a first level of web pages and records all of the hyperlinks in those pages. It then follows every hyperlink found in the first level of web pages to a second level of web pages and indexes every one of the second level web pages before proceeding to any of the third level of web pages (i.e., web pages corresponding to hyperlinks found in the second level web pages), and so on. In other words, the breadth-first method completely indexes each level of a link tree before indexing the next lower level. In contrast to the depth-first and breadth-first methods, the “PageRank” method attempts to rank the URLs by some measure of “popularity.” In order to do so, the Web crawler must have a way to measure the popularity of all of the URLs prior to viewing the individual web pages. In this regard, the PageRank method ranks a particular URL based on the number of web pages that the web crawler has viewed that reference the particular URL. In other words, if the web crawler is indexing a web page and comes across a hyperlink for a URL that is already stored in the frontier, the web crawler adds a “vote” to the referenced URL. Each time the web crawler selects another URL from the frontier to index (step 1140), the web crawler selects the URL having the most votes at that point in time. In the PageRank system, the web crawler may also weight some votes more than others based on the number of votes that the referring web page has.

With regard to step 1160, typical web crawlers index a web page by recording every word that is found in the web page. The words are stored in a datastore along with every URL that corresponds to a web page in which the word was found. Some web crawlers may not index words such as “a,” “an,” and “the.” Furthermore, some web crawlers will, in addition to the URL, record other context information in the index (such as where on the web page the word was found). In addition to indexing words found on the web page, a web crawler may also index any “meta tags” that the web page may have. Meta tags are keywords that may not show up on the face of the web page itself, but are listed by the web page developer in the HTML code as keywords supposedly associated with the web page content.

Another common issue that arises with web crawler development is web crawling ethics, often referred to as “politeness.” Since web crawlers often take up a lot of bandwidth, too many web crawlers accessing the same server at the same time or one web crawler accessing the same server too frequently may decrease the performance of the server's website and hinder other web users from accessing and using the website. As a result, two main solutions have developed so that web crawlers can work in the background of the Web without causing too many problems for individual hosts. The first solution uses what is known as the “Robot Exclusion Protocol” (REP). The REP provides a means for a website developer to indicate to a web crawler whether the developer wants all or part of the host computer to be accessed by web crawlers. The second solution is an ethical solution that most web crawler developers impose on themselves. Specifically, the web crawlers should be designed not to access the same server so frequently as to where significantly degrade the performance of the website hosted by the server. Thus, web crawlers will typically impose some minimum amount of time (often on the order of several seconds) that a crawler must wait between sending multiple requests to access the same server.

### Focused Web Crawling

Since general search engines are designed to provide a master index of as much of the Internet as possible, they require a tremendous amount of computing resources to continually search and research the entire Web and to store all of the indexed information. Furthermore, since the general search engines must have an index that covers as many areas of information as possible, a user of the search engine often receives many unrelated and unwanted web pages in response to a search. As a result, the user must browse through each search result by downloading each web page to determine the actual relevance, if any, of the web page to what the user was looking for.

In an attempt to improve the quality of search results, “focused” web crawlers have developed that are designed to crawl the Web looking for web pages that relate only to a particular topic. Typical focused web crawlers work the same way as a general web crawler in that they execute a loop consisting of the steps of: selecting a web page from a frontier, downloading the web page, and indexing the web page, as described above. Usually the main differences between the traditional general web crawler and the focused web crawler are that the focused crawler: (1) begins with a set of seed pages that contain many hyperlinks related to the topic of interest; (2) includes some sort of algorithm for ranking URLs in the frontier according to their predicted relevancy to the topic of interest; and (3) after it downloads each web page it determines the relevancy of the web page and indexes it accordingly. Naturally, one of the main problems with focused crawling is determining the relevancy of every web page on the Internet with a limited amount of computing resources.

Embodiments of the present invention provide a solution to this problem and other problems associated with focused web crawling and web crawling in general.

### BRIEF SUMMARY OF THE INVENTION

Embodiments of the present invention provide a method of searching a network for information related to a topic of interest, wherein the network comprises a plurality of documents containing information. One or more of the documents are grouped together into a collection of documents so that the network comprises a plurality of collections of documents. The method comprises exploring the contents of one or more individual documents of a collection of documents. The method further comprises making a determination of the relevancy of the one or more individual documents of the collection to the topic of interest. The method also comprises making a determination of the relevancy of the collection based at least partially on the relevancy of the one or more individual documents in the collection.

Embodiments of the present invention further provide a system for gathering information related to at least one topic of interest. The system comprises a multi-tiered system configured for searching a network for information related to at least one topic of interest. Each tier of the multi-tiered system comprises more restrictive criteria than the previous tier for locating the at least one topic of interest. In one embodiment, the network comprises a plurality of collections of documents, each collection comprising one or more documents. In such an embodiment, the system may comprise a first tier configured to obtain a list of collections of documents on the network; a second tier configured to classify each of the collections in the list as being a member of one or more of a plurality of categories; and a third tier configured to examine the documents of at least some of the collections based at least partially on the classification of collections by the second tier.

Embodiments of the present invention also provide a method for requesting web pages from a plurality of web hosts, each web host supporting a finite number of web pages. The method comprises grouping the plurality of web hosts into one or more arrays of web hosts, each array comprising a finite number of web hosts. The method further comprises submitting a first web page request to each web host in an array before submitting a second web page request to any web host in the array.

Embodiments of the present invention provide a method of ranking hyperlinks found on the Internet during a web crawling scheme. The method comprises analyzing text in the immediate vicinity of a hyperlink as the hyperlink is found, and computing a weight for that hyperlink based on the relevancy of the text to a set of interest. The method further comprises storing the hyperlink in a datastore where hyperlinks stored therein are ranked based on the relative computed weights of each hyperlink.

Embodiments of the present invention provide a system for ranking hyperlinks found in a document on the Internet. The system comprises a link weighting system for analyzing text in the immediate vicinity of a hyperlink and for computing a weight for the hyperlink based on the relevancy of the text to a set of interest. The system further comprises a datastore for storing the hyperlink with other hyperlinks in a ranked list based on the relative computed weights of each hyperlink.

Embodiments of the present invention provide a method of determining whether a collection of web pages relates to a topic of interest. The method comprises exploring a web page of the collection of web pages; determining the relevancy of the web page to the particular topic of interest; and making a determination of the relevancy of the entire collection of web pages to the topic of interest based at least partially on the determined relevancy of the web page.

Embodiments of the present invention also provide a system of using a web crawler to classify a collection of web pages. The system comprises a web crawler module configured to search a web page from the collection for links to other web pages in the collection. The web crawler module is further configured to request web pages corresponding to the link that the web crawler finds and to examine such web pages for more links to other web pages in the collection. The system also comprises a classifier module configured to make a determination of the relevancy of each web page that the web crawler examines to a set of interest. The system also comprises a collection classifying system for making a determination of the relevancy of the collection to the set of interest based on the determined relevancy of the web pages that the web crawler examines.

Embodiments of the present invention also provide a method of gathering information related to a particular topic of interest. The method comprises searching a network for information related to at least one topic of interest. Searching the network comprises searching the network in a multi-tiered format such that each tier comprises more restrictive criteria for locating the at least one topic of interest than a previous tier. The method also comprises extracting data from the searched information relating to the at least one topic of interest searched on the network.

Embodiments of the present invention also provide for a system for gathering information related to a particular topic of interest. The system comprises a multi-tiered system configured for searching a network for information related to at least one topic of interest, wherein each tier comprises more restrictive criteria for locating the at least one topic of interest than a previous tier. The system also comprises an information extraction engine configured for extracting data from the searched information relating to the at least one topic of interest searched on the network.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flow chart diagram depicting a typical web crawling system of the prior art;

FIG. 2 is a schematic diagram of a network, such as the Internet, in which embodiments of the present invention may operate;

FIG. 3 is a block diagram showing the multi-tiered structure of a crawling system according to one embodiment of the present invention;

FIG. 4 is a block diagram depicting a more complex embodiment of a multi-tiered crawling system according to another embodiment of the present invention;

FIG. 5 is a block diagram depicting an exemplary embodiment of a multi-tiered crawling system configured to find information on the Web related to real estate listings, according to one embodiment of the present invention;

FIG. 6 is a flow chart diagram illustrating one embodiment of a crawler module according to one embodiment of the present invention;

FIG. 7 is a flow chart diagram illustrating one embodiment of a classifier module according to one embodiment of the present invention;

FIG. 8 is a block diagram depicting one embodiment of the collection harvesting system of one embodiment of the crawling system;

FIG. 9 is a flow chart diagram illustrating one embodiment of a link harvester system according to one embodiment of the collection harvesting system;

FIG. 10 is a flow chart diagram illustrating one embodiment of an IP harvester system according to one embodiment of the collection harvesting system;

FIG. 11 is a flow chart diagram illustrating one embodiment of a targeted harvester system according to one embodiment of the collection harvesting system;

FIG. 12 is a flow chart diagram illustrating one embodiment of a sampler module for use in one embodiment of a collection classifying system;

FIG. 13 is a flow chart diagram illustrating one embodiment of a ranked link extraction system according to one embodiment of the present invention;

FIG. 14 is a flow chart diagram illustrating one embodiment of a sampler module configured to use one embodiment of a ranked link extraction method according to one embodiment of the present invention;

FIG. 15 is a flow chart diagram illustrating one embodiment of a document crawler and classifying system according to one embodiment of the invention;

FIG. 16 is a simplified illustration of one the system and method of politely requesting web pages from web hosts using the cyclic array system/method according to one embodiment of the present invention; and

FIG. 17 is a flow chart diagram illustrating a process for crawling, classifying, and extracting information according to an additional embodiment of the present invention;

FIG. 18 is a flow chart diagram illustrating a system architecture and a process for extracting various data from information identified during a crawling process according to one embodiment of the present invention;

FIG. 19 is a table depicting extraction rules according to an embodiment of the present invention;

FIG. 20A illustrates an HTML source from an HTML file according to an embodiment of the present invention; and

FIG. 20B illustrates an HTML tree structure corresponding to the HTML source of FIG. 20A according to one embodiment of the present invention.

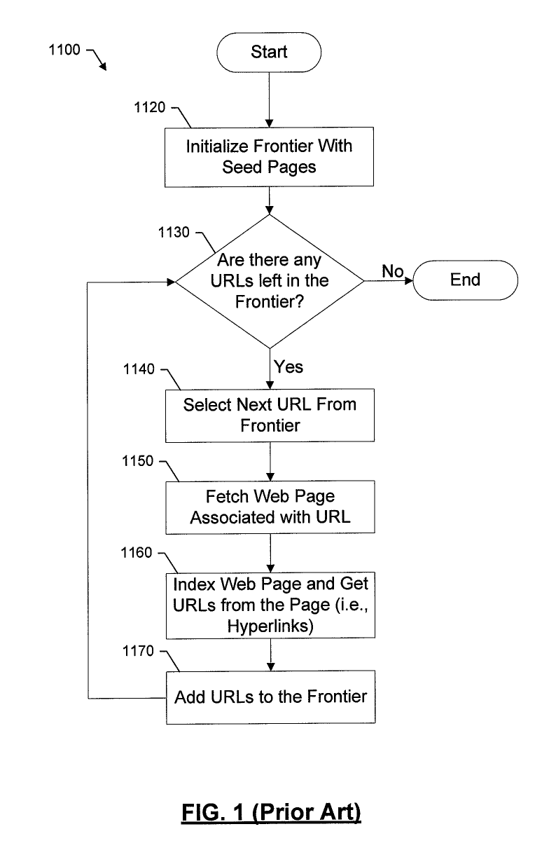

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

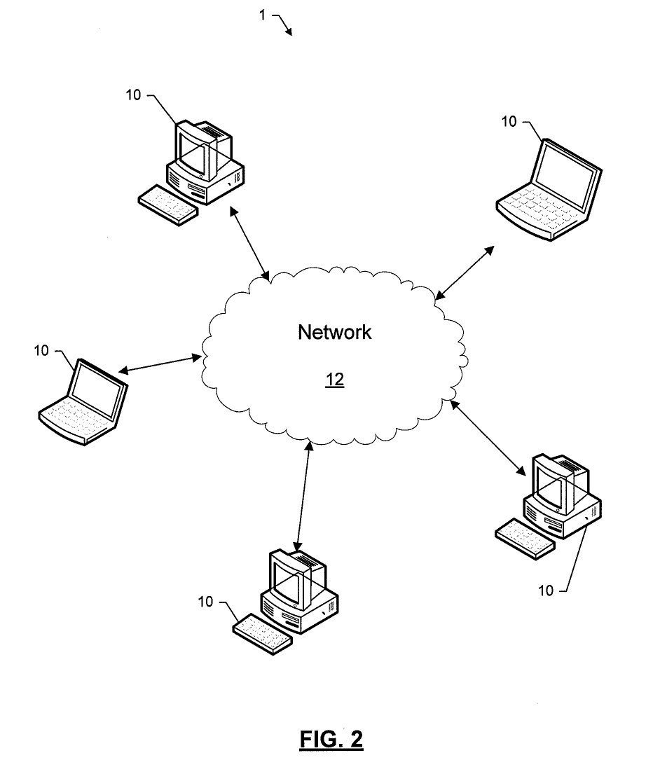

FIG. 2 is a schematic view of an exemplary computer network 1 in which embodiments of the present invention may operate. The network is comprised of a plurality of electronic devices 10 linked together by a communication network 12 so that electronic devices connected to the communication network may communicate with other electronic devices connected to the network. Some electronic devices connected to the network may share information stored in a memory of the electronic device with other electronic devices connected to the network. These electronic devices (or groups of electronic devices) that provide information to other remote electronic devices are often referred to as “hosts.” The host may make the information available to any electronic device on the network or to only certain electronic devices on the network. Some electronic devices are used to connect to the network and to access the shared information on other electronic devices. These electronic devices may download the information from the host device to the electronic device's own memory. These remote electronic devices that access information on the hosts are often referred to as remote “terminals.” The network 1 may comprise one or more protocols or conventions that are designed to standardize aspects of the network, such as the way in which information is transferred over the network, how electronic devices communicate with each other over the network, how network information can be displayed on an electronic device, how the user can interact with that information, and the like.

The computer network 1 may comprise many individual documents stored on various networked electronic devices. These documents may be associated with one or more document identifiers that allow the document to be uniquely identified and referred to on the network. In some instances, the documents on the network may be able to be grouped into collections of documents. For example, the documents may be grouped into collections based on some common aspect of the documents, such as a common host device, a common portion of the identifier, a common author, source, or origin, or any other common aspect. Preferably, there is a way to identify a collection of documents, such as a collection identifier, so that each separate collection can be uniquely identified, referred to, and/or recalled. For example, each collection of documents may contain a main or primary document. In one embodiment of the present invention, the document identifier for the main document may be used as the collection identifier.

One example of a network that one embodiment of the present invention may be configured to operate in is the Internet. As described above, the Internet is a global computer network involving hundreds of millions of interconnected devices. Some exemplary embodiments of the present invention may also be configured to operate on the Internet specifically in the World Wide Web (the “Web”). As also described above, the Web is a standardized system of communication, linking, and displaying information on the Internet. For example, a host device may have documents stored in the device that contain information written using a standardized language, such as HTML. The host device may make these documents available on the network. Remote terminals can then request the document from the host device (e.g., by making an HTTP request) and then download the document. The remote terminal may have a web browser that can interpret the standardized language and display the information in the document on the remote terminal's monitor. Such documents on the Web are often referred to as web pages. Each web page has a unique identifier, such as a URL, that can be used to refer to and request the web page on the network.

One or more web pages may be grouped into collections of web pages, often referred to herein as “websites.” As described earlier, the groupings may be based on a common host device, a common IP address, a common domain name, and/or any other identifiable aspect common to a group of web pages. For example, each collection may be uniquely identifiable and/or individually accessible on the network by a URL that accesses a home directory of the host. Often, the home directory comprises a main web page for the website. Such a web page is often referred to as a “home” page from which the other web pages in the website are often accessible via one or more hyperlinks. Some individual web pages of a website, however, may not be directly accessible via hyperlinks on a home page and instead may only share a common domain name portion of the URL. Similarly, some information and pages connected to a website may not be accessible by a hyperlink since the information or web page may be located in a data repository stored on the host device (or other device) but accessible to a remote terminal only by submitting information into a form on a web page. As described above, web pages and other information accessible through such forms represent much of what is known as the “deep” or “hidden” Web, where a large percentage of the information on the Web is located.

In some embodiments of the present invention, each website is considered to be a separate collection of documents on the Internet. It is often assumed that websites usually comprise pages having at least some common subject matter. Sometimes, however, very large and general websites may provide information on a wide variety of subjects. As such, some embodiments of the present invention may further subdivide some websites into smaller collections of web pages, such as branches or paths of a website (a “path” being a collection of nodes usually beginning with the “root” node). For example, a collection identifier according to one embodiment of the present invention may be a specific node of a URL or a specific path within a URL.

In order to find and/or classify information on a network, such as the network 1 described above, embodiments of the present invention provide systems for searching and/or classifying information on a network, such as web pages (or information found in web pages) that are located on the Internet. In particular, embodiments of the present invention are directed to efficiently finding, searching, and/or classifying documents or web pages on a network that are likely to be relevant to one or more particular topics or subtopics of interest. In some embodiments of the present invention, the system also extracts the relevant data from the relevant documents or web pages. In still further embodiments, the system is configured to compile the extracted data into a usable form (e.g., a searchable datastore for use by a network user).

### Multi-tiered Cascading Network Crawling System

According to one embodiment of the present invention, a multi-tiered cascading crawling system is provided for finding information on a network related to one or more predetermined topics or subtopics of interest. In general, embodiments of the present invention provide a system that operates in multiple “tiers,” where at least some of the output of one tier is used to comprise the input of the next tier. Each tier generally analyzes collections of documents on the network using successively more restrictive criteria about the subject matter of each collection and/or about which collections may be related to the one or more topics or subtopics. In this way, each tier may use knowledge gleaned from its predecessors to refine its understanding of a collection of documents. In general, only the final tier performs an exhaustive crawl of all of the documents of the collections that are identified by the system as being relevant to the topic or subtopic of interest. Furthermore, only the documents from collections that remain at this last tier have data extracted from them and/or are saved, indexed, or otherwise used by other systems or subsystems. In this way, embodiments of the present invention may provide a more efficient system and method of conducting a focused crawl of a network. Specifically, unlike the traditional crawlers that search for web pages on the Internet and then download, analyze, and index each web page at the time the page is found, embodiments of the present invention search for collections of documents and make an initial determination as to the content of the collection as a whole. This allows successive tiers of the system to make increasingly detailed determinations about each collection of documents and, thereby, saves computer resources for conducting a detailed analysis of only the documents contained in the most relevant collections.

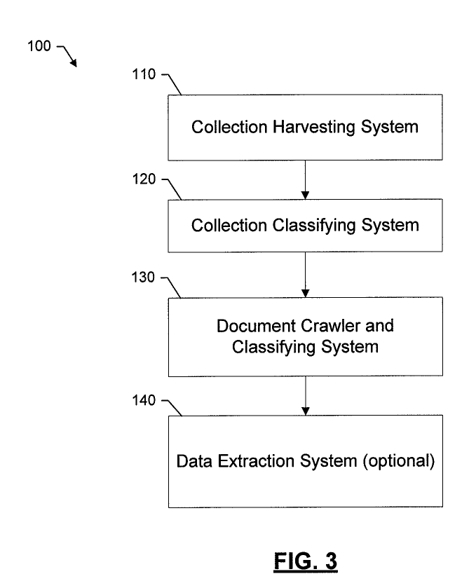

FIG. 3 is a block diagram illustrating the basic architecture of a crawling system 100 according to one embodiment of the present invention. The system of FIG. 3 comprises a collection harvesting system 110, which provides data to a collection classifying system 120, which provides data to a document crawler and classifying system 130, which provides data to some other data processing system such as a data extraction system 140.

The collection harvesting system 110 is configured to obtain a list of collections of documents that exist on the network. For example, the collection harvesting system 110 may be configured to find or otherwise obtain collection identifiers that can be used to identify the collections of documents. The collection identifiers provided by the harvesting system may then be used by the collection classifying system 120. The collection classifying system 120 may be configured to receive a collection identifier from the harvesting system 120 and use the collection identifier to access at least a portion of the collection on the network. The collection classifying system 120 may then analyze one or more documents from the collection to make assumptions or determinations about the content of the collection as a whole, such as whether or not, or to what extent, the collection may relate to one or more predetermined topics or subtopics. If the collection classifying system 120 determines that a collection potentially includes information related to the particular topic or subtopic, the collection identifier for that collection may be provided to the document crawler and classifying system 130. The document crawler and classifying system 130 may be configured to search for documents in the potentially relevant collections and analyze each available document to determine whether, or to what extent, each document relates to one or more topics or subtopics of interest or whether any of the documents contain some particular types of information related to the topics or subtopics of interest.

The information pertaining to the relevancy of one or more documents to a particular topic or subtopic may then be used for many purposes. For example, in one embodiment of the present invention, the documents or document identifiers may be stored in a datastore and indexed based on the determined relevancy of the document to a particular topic or subtopic. In the embodiment of the invention depicted in FIG. 3, documents that the document crawler and classifying system 130 determines to be relevant to the particular topic or subtopic are then output to a data extraction system 140 for extracting the relevant data from the relevant document.

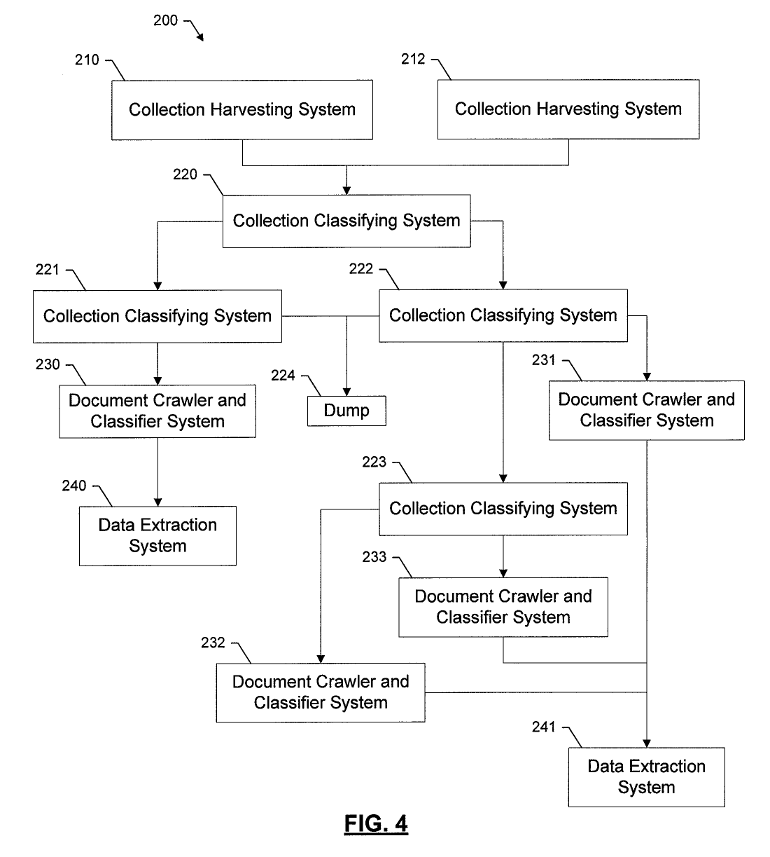

As described above, FIG. 3 represents the basic subsystems of the crawling system according to one embodiment of the present invention. It should be appreciated that these subsystems may be duplicated and configured to operate in series or in parallel to form more complex focused crawling systems. In this regard, FIG. 4 illustrates a more complex crawling system 200 according to one embodiment of the present invention. In the first tier of the system, FIG. 4 illustrates two collection harvesting systems 210 and 212 used to obtain the identifiers for as many collections of documents as possible. Different methods of harvesting collection identifiers may exist, each having their own strengths and weakness for locating collection identifiers on the network. As a result, it may be desirable in some embodiments of the present invention to use more than one harvesting system at the same time. For example, one harvesting system 210 may comprise searching every possible host device on the network in order to find collection identifiers. The other harvesting system 212 may comprise crawling through documents on the network to locate collection identifiers. In another embodiment, a third harvesting system may comprise purchasing, or otherwise obtaining, pre-derived lists of collection identifiers from external sources. Exemplary embodiments of different harvesting systems are described in greater detail below.

The collection identifiers that are obtained by the harvesting systems are provided to one or more collection classifying systems 220. The collection identifiers may be provided directly to the classifying systems or they may be provided to a datastore where the collection identifiers are stored for the classifying systems to later fetch and use. When multiple harvesting systems are used in parallel, the individual systems may obtain at least some of the same collection identifiers. In some embodiments, duplicate identifiers are simply eliminated. In other embodiments, obtaining duplicate identifiers may signify that the identified collection is more popular or otherwise more or less significant to the focused crawl and as such, may be weighted more or less heavily than other collection identifiers. In some embodiments of the present invention, collection identifiers that are weighted more heavily may be selected by the collection classifying system 220 before collection identifiers that are weighted less heavily.

As illustrated in FIG. 4, a collection classifying system 220 receives collection identifiers found by the harvesting systems 210 and 212. FIG. 4 illustrates how the collection classifying system in this embodiment sorts all of the collections into two sets, each set having its own multi-tiered cascading subsystem. For example, collection classifying system 220 may analyze at least a portion of the documents in each collection to determine the language that the document information is written in. The collection classifying system 220 may then output each collection identifier to one or more different subsystems dependent upon the language(s) that were found in the documents of the collection that were analyzed by the collection classifying system 220.

For each category used to divide the collections there may be any number of additional collection classifying systems such as the two shown as 221 and 222. These collection classifying systems 221 and 222 can be used to further classify the collections of documents into subsets. Each collection classifying system can also make assumptions about the collections that it receives based on the collection classifying systems that came before it in the cascade. For example, the collection classifying system 221 may be configured to analyze at least some of the documents in each collection to determine whether the collection is relevant to the particular topic of interest. For instance, the collection classifying system 221 may look for keywords or phrases that are related to the topic of interest. In the example where classifying system 220 sorts collections based on language, every collection that classifying system 221 receives contains at least some information written in a particular language. As such, the keywords and phrases that the classifying system uses can be tailored to that particular language.

In the embodiment of the present invention where the collection classifying systems 221 and 222 are configured to further classify the collections based on relevancy to the topic of interest, the classifying systems 221 and 222 may be configured to analyze at least a sample of the documents in each collection and make a determination of the relevancy of the entire collection based on the determined relevancy of the sampled documents. Specifically how embodiments of the collection classifying systems may analyze sample documents from a collection and, thereby, make a determination of the relevancy of the collection, is described in detail below. Collections that are determined to have a relevancy greater than a threshold relevancy may be output into a document crawler and classifying system 230. If classifying system 221 deems a collection to be irrelevant to the topic of interest, the classifying system 221 may simply not output such irrelevant collections or, alternatively, may output these collection identifiers into a dump datastore 224 where this information could be used for diagnostics purposes or other purposes.

As illustrated in FIG. 4, collection classifying system 222 is configured to “dump” collections that it deems to be irrelevant. In “dumping” a collection it is generally meant that the collection is ignored in any subsequent processing during the current run through the cascade. In some embodiments, dumped collections are deleted, but, in other embodiments, the dumped collections may be saved for other purposes, such as for manual review or for resubmission after a change is made to the collection classifying system or to the cascade in general. Collection classifying system 222, however, is also configured to further classify the collections that it deems relevant into further subsets, perhaps related to subtopics of interest or different document formats. Collection classifying system 222 outputs some collections directly to a document crawler and classifying system 231 and outputs other collections to another collection classifying system 223 where the collections can be further subdivided based on such things as the content or format of the sampled documents of each collection.

As can be seen by comparing classifying systems 220 and 221, some classifying systems may allow a single collection to be placed in more than one subset, while other systems require that the collection be placed in either subset or another, and not multiple subsets. For example, if ten documents of a collection are analyzed by a collection classifying system configured to classify collections based on language, the collection identifier may be output to ten different collection classifying systems, one for each language. However, where the collection classifying system is configured to make an assessment of a collection's relevancy to one particular topic, the collection must be deemed to be either relevant or not relevant (or undecided), and the collection must be either sent on to the next tier in the cascade or removed from the cascade.

Once the collections are provided to a document crawler and classifier system, the collection is crawled for documents and each document is individually analyzed and classified as either containing relevant information or not containing relevant information. This crawling and classifying of each document in a collection is conducted by the document crawler and classifier systems 230, 232, and 233. The documents that are deemed to contain relevant information may then be output to one or more data extraction systems 240 and 241. It should be appreciated that the classification conducted by the document crawler and classifier system can make assumptions about the documents based on the document having reached this point in the cascade. As a result, the classification is always a narrowing or a focusing of the information believed to be known about the collection and/or document.

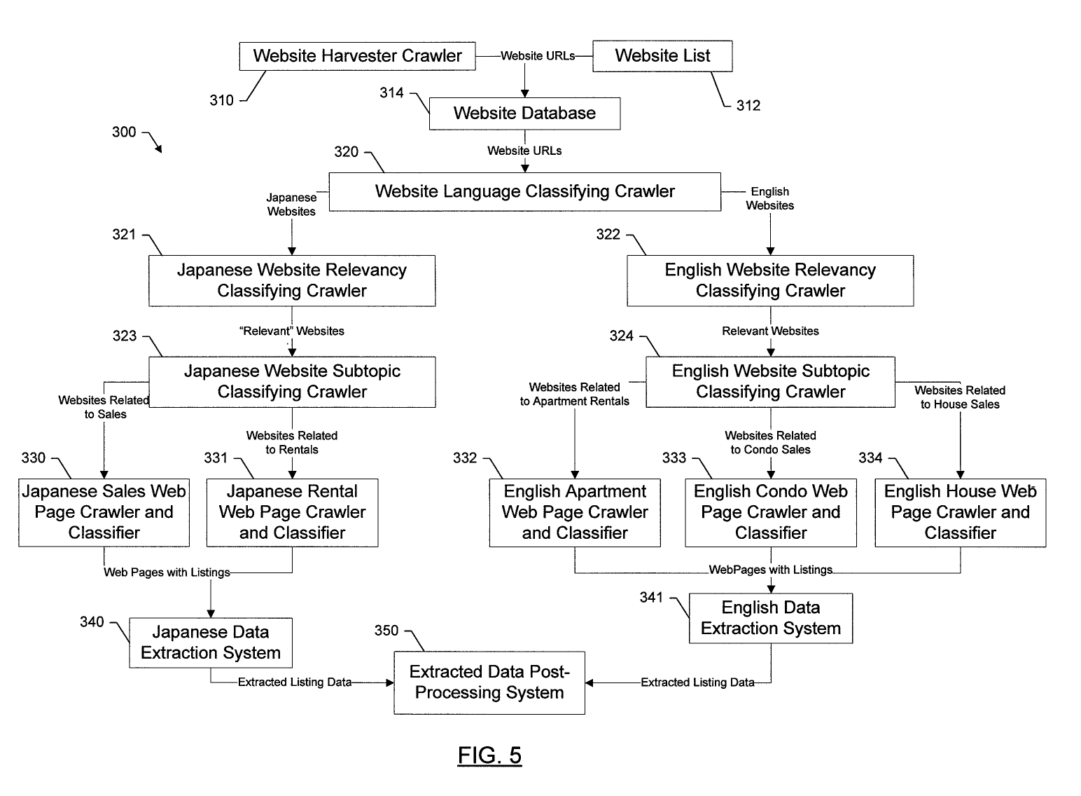

FIG. 5 illustrates one exemplary embodiment of the present invention and should not be construed as limiting other embodiments of the present invention. In particular, FIG. 5 illustrates a focused crawling system 300 for searching the Web for real estate listings, such as home sale listings, apartment rental listings, and the like, and extracting and compiling such information. The focused crawling system 300 includes a website harvesting system for obtaining the URLs for as many website homepages as possible. Specifically, this website harvesting system is comprised of a website harvester crawler 310 and a website list 312. As will be described in greater detail below, the website harvester crawler 310 is configured to crawl the Web recording every website URL that it comes across. The website URLs are saved in the website datastore 314. The website list 312 is a list of website URLs that have been purchased or otherwise obtained from some external source. These website URLs are also stored in the website datastore. Duplicate website URLs in the datastore may be eliminated. In one embodiment, when the website harvesting system 310 finds a form on the web, the website harvesting system 310 is configured to generate “pseudo URLs” that represent form posts that, to a host, are generally indistinguishable from a human submitting a form. The website list 312 may also contain such “pseudo URLs” in addition to the regular URLs. Note that, for simplicity when the term URL is used below, the URL may be either a regular URL or a pseudo URL.

The next tier of the crawling system 300 comprises a website language classifying crawler 320. The website language classifying crawler 320 is configured to crawl each website and analyze at least one or more of each website's web pages to determine the language(s), or dialect(s) used to present information in the website. In addition to or as an alternative to determining languages and dialects, the website language classifying crawler 320 may be configured to determine the locale of the website, the website's creator, and/or the website's audience if such may be relevant to the linguistic features of the website. For example, what people on the U.S. west coast refer to as a “studio” might be more commonly referred to as an “efficiency” on the U.S. east coast. As a result, in some embodiments, it may be useful to classify US/NorthEast as separate from US/WestCoast because, although the language and the dialect may be the same, the terminology and common phrases by which real estate (or whatever the topic of interest might be) may differ. Determining such a difference and separating the websites based on such a difference in an early stage of the cascade may allow both classification and extraction to be more precise and/or efficient.

In some embodiments, the language crawler 320 may be configured to classify a website into one or more of many languages, dialects, and/or locales. In other embodiments, the language crawler 320 may only be concerned with finding websites in only one particular language, dialect, or locale, and, as such, is configured to only output websites in that language, dialect, or locale to the next tier of the main crawler 300. FIG. 5 illustrates an embodiment of a crawler where the language crawler 320 looks for websites that present information in either English or Japanese and passes these websites to the next tier in the main crawler. Websites that are deemed to be written in English are passed to an English website relevancy classifying crawler 322 and websites that are deemed to be written in Japanese are passed to a Japanese website relevancy classifying crawler 321.

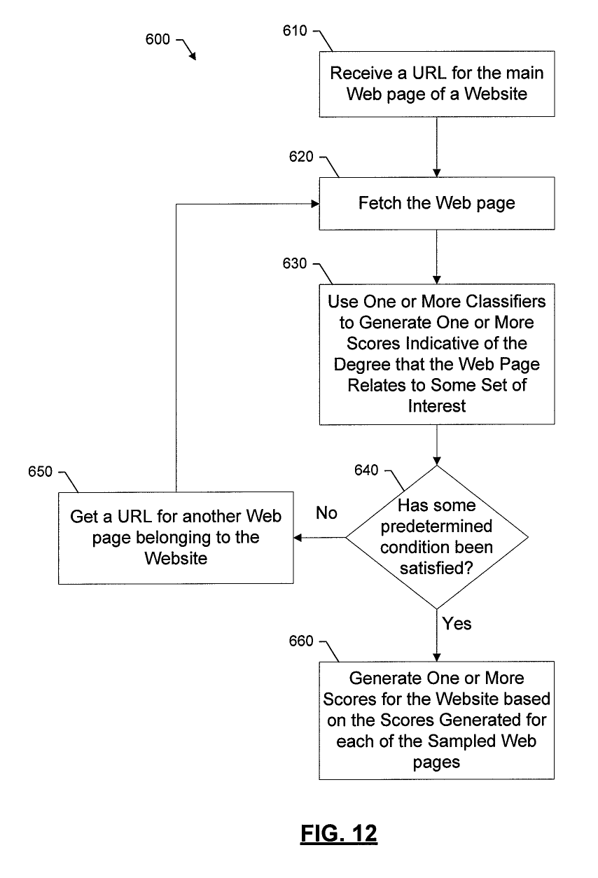

In the focused crawler 300 of FIG. 5, the website relevancy classifying crawlers 321 and 322 are configured to crawl at least a portion of the web pages of each website that it receives. The website relevancy classifying crawler is configured to analyze the one or more web pages that it crawls in order to determine whether the website is likely or unlikely to contain real estate listings. Methods of crawling and analyzing a portion of the web pages of a collection of web pages in order to make determinations about the websites as a whole are described in greater detail below in the discussion of FIG. 12. Since the websites that the English relevancy crawler 322 receives all must contain at least some information written in English, the English relevancy crawler 322 may be tailored to only search for terms or phrases that may be used in the English language to refer to real estate listings.

Any website URLs for websites that are deemed by the website relevancy classifying crawlers to be “relevant” (e.g., websites that received a relevancy score from the website relevancy classifying crawlers greater than some relevancy threshold) are passed to the next tier in the focused crawler 300. FIG. 5 illustrates that the next tier in this crawler comprises Japanese and English website subtopic classifying crawlers 323 and 324. The website subtopic classifying crawlers 323 and 324 are configured to place the relevant websites into one or more subcategories of the topic of interest. Like the relevancy classifying crawlers 321 and 322, the subtopic classifying crawlers 323 and 324 can be tailored for the particular language of the websites that it receives. For example, for the crawler 300, the website subtopic classifying crawler may sort the websites between those related to rentals and those related to sales, as FIG. 5 shows the Japanese website classifying crawler 323 as doing. FIG. 5 shows the English website classifying crawler 324 placing websites into categories related to apartment rentals, condo sales, and home sales.

After determining what category or categories the websites best fit into, the website URLs are then provided to web page crawler and classifier systems 330-334 that correspond to the each of the categories of websites. For example, the URLs for the English websites that are related to apartment rentals are provided as input for an English apartment web page crawler and classifier 332. The web page crawler and classifier systems are configured to exhaustively crawl the websites to determine which web pages of the websites have real estate listings. Since there is a web page crawler and classifier system for each category of the topic of interest, the individual web page crawler and classifier systems can each be tailored to search for listings related to the particular category and language. For example, the typical apartment rental listing may use very different terminology and/or formats than typical home sale listings. As a result, it may be beneficial to use different web page crawler and classifier systems, each crawler and classifier system tailored to find either apartment listings or home sale listings. Furthermore, since this tier is usually the only tier in which each available web page of a website is exhaustively crawled, downloaded, and analyzed, the computing resources are efficiently used since this exhaustive crawl is only conducted on a limited subset of the Internet that has been determined to be “relevant” at least to some degree.

Web pages that are determined to include listings are output from the web page crawler and classifier systems to a processing system where the listing information can be used. In the crawler 300 illustrated by FIG. 5, the web pages having listings are provided to one or more data extraction systems 340 and 341. In this embodiment, the data extractions systems are configured to extract the listings from the web pages and provide the extracted listing information to a post-processing system 350 where the listing information is compiled and indexed. FIG. 5 illustrates separate data extraction systems 340 and 341, one tailored for each language. Other embodiments may use only one data extraction system to extract data from all of the web pages that have listings. Other embodiments may comprise separate data extraction systems for different subcategories of the topic of interest. For example, if typical apartment rental listings are generally formatted on the Web differently than typical home sale listings, it may be desirable to have separate data extraction systems tailored to extract data from each category of listing.

Now that embodiments of a multi-tier cascading focused crawler have been described, the individual systems and subsystems that are used to comprise at least some embodiments of the crawler are described in detail below. Although the embodiments of these systems and subsystems of the present invention are described below with respect to the Web, the present application should not be considered as being limited only to the Web. It should be appreciated that embodiments of the present invention may be configured to operate in other types of networks and with other types of network protocols. Furthermore, although the below systems and subsystems are described as being used as part of the multi-tiered crawling system of the present invention, the below systems may be novel in their own right, independent of their use with the multi-tiered cascading crawler.

### Crawlers and Classifiers

It should be appreciated that embodiments of the present invention provide for a modular crawling system that can be arranged, rearranged, and finely tuned to create an efficient focused crawling system for the large, complex, and often-changing networks such as the Internet. The basic building blocks for many of the systems and subsystems of some embodiments of the present invention include the crawler module and the classifier module.

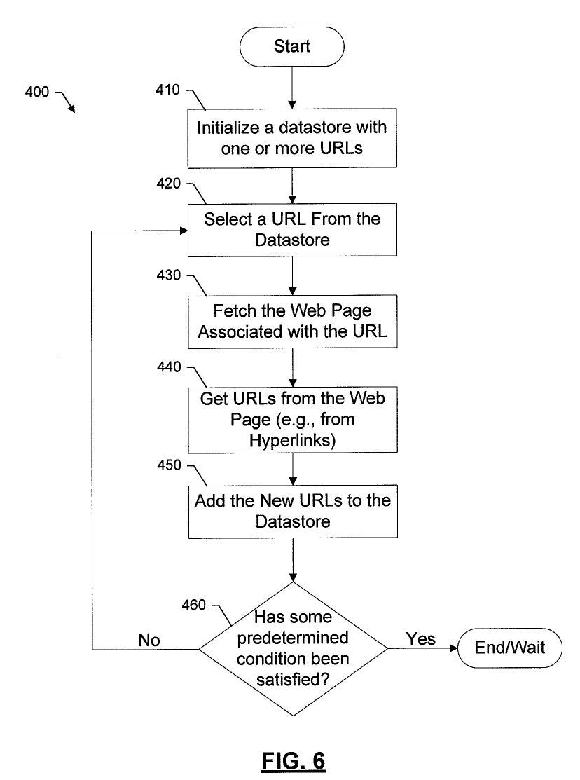

FIG. 6 illustrates a flowchart for a web crawler module 400 configured to locate and output web pages/sites based one or more input web pages/sites. In general, the crawler module 400 is configured to receive a URL as input, for example, by selecting a URL from a datastore that has one or more URLs stored therein (steps 410 and 420). The crawler module 400 may then submit a request (e.g., an HTTP request) to a host on the network requesting the web page corresponding to the URL (step 430). Once the web page is received, the crawler finds hyperlinks that are identified on the web page (step 440) and saves the hyperlinks to the datastore (step 450). The crawler then returns to step 410, selects one of the hyperlinks from the datastore, and searches the corresponding web page for more hyperlinks. These hyperlinks are also saved to the datastore. This loop continues until either there are no more links in the datastore or until some other predetermined condition is satisfied (step 460).

In one embodiment, in addition to or as an alternative to using hyperlinks to locate new URLs, when the web crawler module 400 encounters a web page having a form, the web page crawler module 400 may generate “pseudo URLs” that simulate a user entering information through the form. For example, the web crawler module 400 may be configured to evaluate a form written in JavaScript and create pseudo URLs that correspond to different possible variations of a form post. These pseudo URLs may then be saved to the datastore. Other methods known in the art or made obvious by the present disclosure of finding new URLs may also be employed by the web crawler module 400. For simplicity, the following description discusses the crawling process and system primarily in terms of finding and storing hyperlinks, however, it should be appreciated that embodiments of the present invention may be configured to find new URLs using other methods, such as by evaluating forms and generating pseudo URLs in order to crawl web pages accessible through such forms.

As will be described below, the crawler may be free to crawl the entire network or the crawler may be configured to only crawl a limited segment of the network. For example, in one embodiment the crawler may be limited to crawling only web pages of a particular website (i. e., “internal” web pages). Embodiments of this crawler module 400 are used to create at least some aspects of the multi-tiered network crawling system according to some embodiments of the present invention.

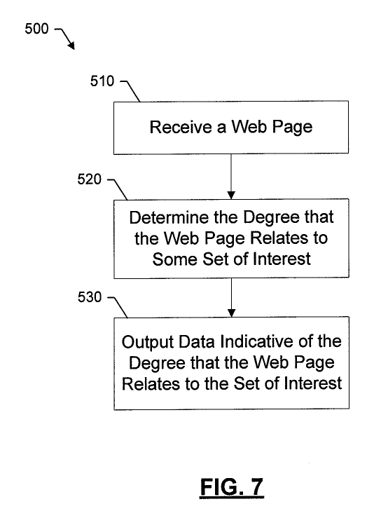

FIG. 7 illustrates an embodiment of a classifier module 500, another basic component used in at least some elements of embodiments of the present invention. The classifier module 500 is configured to receive a web page as input (step 510) and analyze the contents of the web page to determine the degree to which the web page relates to some set of interest (step 520). For example, a classifier may be configured to examine the contents of a web page to determine if the web page is “relevant” or “irrelevant” to a particular topic. The definition of what is to be considered “relevant” depends on the configuration of the classifier 500. For example, a classifier may determine relevancy of a web page based upon the existence or the density of keywords or phrases in the web page. Classifiers may also be configured to examine other aspects of a web page other than the textual content. For example, the classifier may be configured to determine whether the web page is greater than or less than some predetermined threshold size.

After analyzing the web page, the classifier generally is configured to output data indicative of the relevancy of the web page to the set of interest. Typically, the output of a classifier is a “yes” or a “no,” although some classifiers can be configured to produce a result of “indeterminate.” For example, the classifier may be configured to output a score of 0 if the web page is not determined to be a member of the set of interest, a 1 if the web page is determined to be a member of the set of interest, and a null value if it is indeterminate whether the web page is a member of the set of interest. Other classifiers may output a numerical score within a range of scores, such as a number between 0 and 1. Some classifiers can output 0, 1, and null scores.

### Collection Harvesting Systems

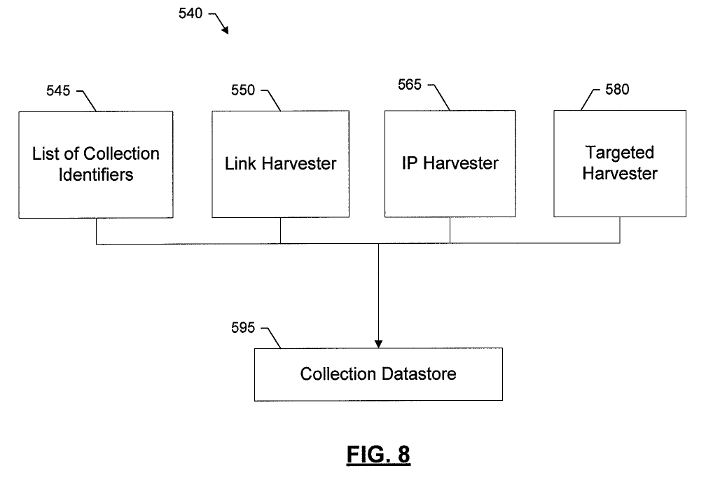

As described above, embodiments of the present invention comprise one or more collection harvesting systems configured to obtain a list of identifiers that can be used to identify and/or access collections of documents on the network. The primary goal of the harvester system is usually to generate as many collection identifiers as possible to feed into the classifying systems. Different systems for obtaining collection identifiers may be created, each system having its own strengths and weaknesses. As such, embodiments of the present invention may be configured to use more than one harvesting system to generate the list of collection identifiers. FIG. 8 illustrates a harvesting system 540 according to one embodiment of the present invention. The illustrated harvesting system 540 comprises four types of harvesting systems operating in parallel to generate a datastore 595 of collection identifiers.

Harvesting system 545 illustrates one harvesting system of an embodiment of the present invention. The harvesting system 545 involves purchasing, or otherwise obtaining, a predetermined list of collection identifiers. For example, in one embodiment, a list of known websites, domain names, URLs, or IP addresses may be purchased from some other source. In one embodiment, such a list may comprise identifiers for collections of documents, such as websites or website branches, that are known to generally relate to some particular topic of interest that may be similar to the topic of interest of the focused crawler system.

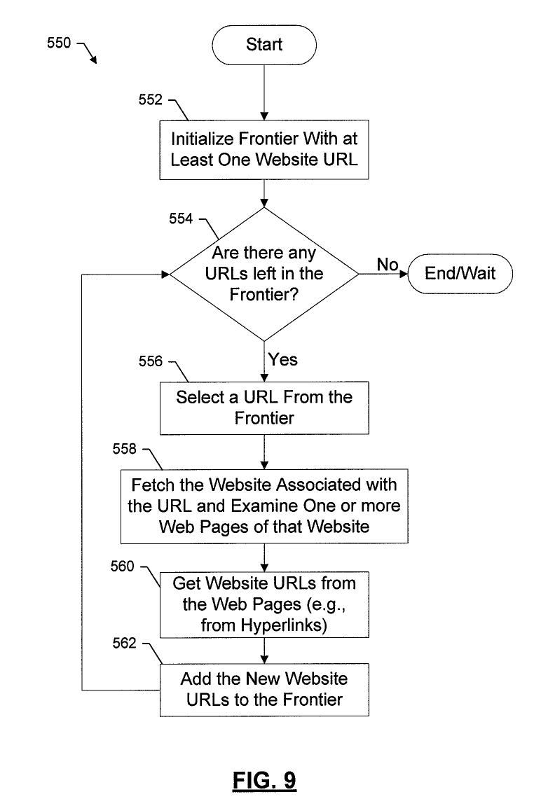

FIG. 9 illustrates a link harvester 550, another type of harvesting system according to one embodiment of the present invention. The link harvester 550 is generally initially provided with one or more URLs in the frontier corresponding to one or more collections of websites (step 552). Although the initially provided websites may be any website, preferable the website that is initially provided is a large directory-type website that provides hyperlinks to many other websites. The link harvester 550 is then configured to fetch one or more web pages from each site in the frontier (step 558) and collect all hyperlinks to other sites that it finds (step 560). The URLs for these hyperlinks are added to the collection datastore 595 for later use by the classifying systems, and the URLs are also added to the frontier that the link harvester 550 draws from in its search for new websites (step 562). The link harvester then selects another website from the frontier (step 556) and repeats steps 558-562 and step 556. Each new site visited produces new external links to new websites (or other collections of web pages). In one embodiment, the system is configured to only visit a limited number of web pages from each website. The link harvester system may be particularly suited to finding popular sites, but may not be as well suited for finding sites that do not rely heavily on incoming links from other sites to create traffic.

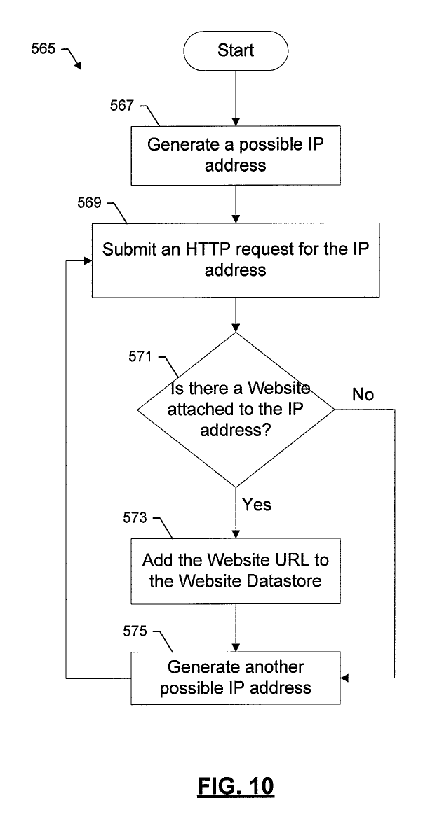

FIG. 10 illustrates an IP Harvester 565, according to one embodiment of the present invention. The IP harvester 565 is configured to exhaustively examine every possible identifier of a set of identifiers (e.g., IPv4 addresses, IPv6 addresses, etc) that may be used to identify a host to see if a web server is connected to the identifier. The IP harvester 565 begins by generating a possible identifier, such as an IP address, (step 567) and submitting some request over the network, such as an HTTP request, to the generated identifier (step 569). If a web server responds, the IP harvester stores the identifier and/or the website URL hosted by the web server in the collection datastore 595. The IP harvester then repeats the process of generating another identifier and submitting a request to this new identifier. If a server does not respond, the IP harvester proceeds with generating another identifier and trying to submit a request to the new identifier. This technique for locating website or host identifiers (e.g., IP addresses) may be advantageous since it is equally good at finding popular sites as it is at finding secluded sites. Furthermore, the rate of discovery is fairly constant and it does not have the problem of finding the same sites over and over again as with other crawlers.

In one embodiment of the IP harvester, the steps of submitting a request to an identifier 569 and determining if a web server (host) responds 571 is comprised of requesting the a robots.txt file from the identifier. The robots.txt file holds a host's robot exclusion policy. If the host returns a policy indicating that crawlers are allowed to crawl the host's home page, the host is considered a “hit” and the corresponding website is added to the collection datastore 595. If the host returns a “file not found” error, that means there is a web server listening with no robot restrictions and the host is also considered a “hit” and the corresponding website is added to the collection datastore 595. Only if the host fails to respond at all, or if the host's robot policy forbids visiting the home page, does the IP harvester consider the host a “fail” and not add the corresponding website to the collection datastore. This embodiment of the IP harvester 565 has the added advantage of satisfying at least some of the politeness requirements by only collecting sites that are allowed to be crawled.

In some embodiments of the IP harvester, at least some failed identifiers may be kept in the collection datastore. For example, in one embodiment, all the failed identifiers are kept in a datastore, but the failed identifiers are separated between those that failed due to a lack of response and those that failed due to a robot exclusion policy. For the identifiers where no response was received, these identifiers may be ignored by the crawler. For the identifiers where the robot exclusion policy forbids crawlers, the crawler might recheck the host or the corresponding website periodically to see if the robot exclusion policy or the host has changed.

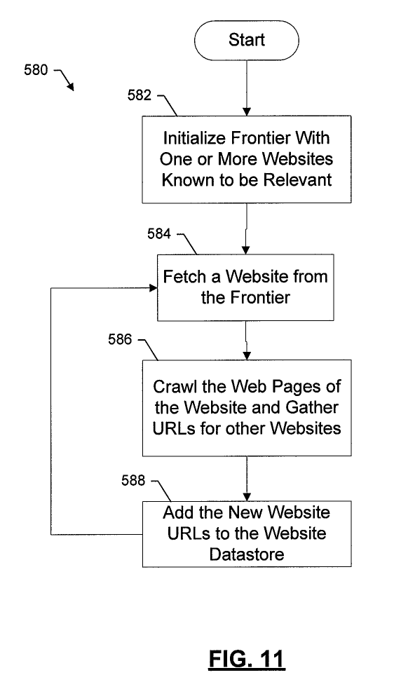

FIG. 11 illustrates a Targeted Harvester 580, according to one embodiment of the present invention. The targeted harvester 580 is similar to the structure of the link harvester, except that the targeted harvester is initially provided with one or more websites that are known to be related to the topic of interest or are known to contain links to websites related to the topic of interest (step 582). The targeted harvester 580 is then configured to fetch specific web pages from each of the known websites (step 584) and collect all of the hyperlinks to other sites that it finds (step 586) (and/or, as described above, generate pseudo URLs from forms on the web pages). In one embodiment of the targeted harvester, the harvester also records the number of times that a link to a website is found in the known websites. The URLs for the websites that are found may then be added to the collection datastore 595 for later use by the classifying systems (step 588). The targeted harvester then selects another website from the frontier (step 584) and repeats the loop until the frontier is empty. Since the websites crawled by the targeted harvester are known, the targeted harvester may be tailored to crawl any peculiarities in the website's structure so that at many of the web pages of the site may be crawled. Depending on the relevancy of the known websites and perhaps on the number of times a found website is referred to in the known website, the multi-tiered crawler system may allow the websites output by the targeted crawler 580 to bypass one or more collection classifying tiers, such as tiers that are configured to determine if the websites are relevant to the topic of interest.

### Collection Classifying Systems—Using Crawlers to Classify Collections of Documents

As described above, embodiments of the multi-tiered crawling system comprise collection classifying systems for classifying a collection of documents as belonging to some set of interest based at least partially on an analysis of one or more documents in the collection. Embodiments of the collection classifying systems described below are configured to operate on the Web to classify collections of web pages. Although these embodiments are described in terms of the Web, other embodiments may be configured to operate on other networks using other communication protocols. Furthermore, the embodiments described below are described as being configured to classify websites (i.e., web pages originating from a common host). However, as described earlier, embodiments of the present invention may be configured to classify other types of collections of web pages, such as branches of websites, web pages having a common portion of a URL, web pages having a common domain name, web pages originating from a common IP address, and the like.

Collection classifying systems generally include one or more sampler modules. FIG. 12 is a flow diagram illustrating one embodiment of a sampler module 600 for use in a website classifying system. The sampler module 600 is generally comprised of a combination of a crawler module 400 and one or more classifier modules 500. As FIG. 12 illustrates, a sampler module 600 may be configured to receive a URL for a main web page of a website (step 610), such as the website's homepage. The sampler module 600 then fetches the webpage corresponding to the URL (step 620), for example, by submitting an HTTP request to the appropriate server on the network and downloading an HTML document. The sampler module 600 then uses one or more classifier modules 400 to generate one or more scores indicative of the degree that the web page relates to some set of interest (step 630). The sampler module may then be configured to determine if some predefined condition has been met before proceeding (step 640). For example, the condition may be whether some predetermined number of web pages has been sampled for the website. In this example, if the sampler module has not yet sampled the requisite number of web pages for the website, the sampler module proceeds to step 650 where the sampler searches the current web page for a hyperlink or a URL corresponding to another web page of the website. The sampler module then returns to step 620 where it fetches the web page corresponding to the hyperlink or URL and uses the classifiers to generate one or more scores for this web page. In this example, the sampler would repeat these steps until either the requisite number of web pages has been scored for the particular website or no more web pages for that website can be found.

In other embodiments of the sampler module 600 displayed in FIG. 12, step 660 may come before step 640. In other words, the sampler may calculate a running aggregate website score during each iteration of the loop. In this way, the predefined condition of step 640 may be based on the running aggregate score for the website. For example, the condition may be that “if a website score is at any time greater than some threshold score, the sampler exits the loop and uses that score as the website score.” For example, such a condition may be useful to conserve computing resources if a website is being analyzed by a sampler for relevancy to a particular topic of interest and one web page of the website is determined to have a high correlation to the topic of interest. In some embodiments of the present invention it may be desirable to stop the sampler from further analyzing other web pages of the website as soon as such a relevant web page is found if the website will be considered relevant regardless of the relevancy of any other web pages in the website.

According to one embodiment of the present invention, a plurality of classifier modules may be used together in series or in parallel with each other to produce one or more scores for a given document. Thus a sampler may comprise one or more classifiers linked together in series or in parallel. For example, a chain of classifiers may be linked together in series so that a classifier lower in the chain can make assumptions about a web pages it receives based on the scores given by the classifiers higher in the chain. The chain of classifiers generally comprises a chaining rule that determines how the individual classifier scores are to be combined. Examples of chaining rules may include: (1) a higher score always replaces a lower score; (2) scores of exactly zero or exactly one cannot be altered regardless of the subsequent scores; (3) scores from a higher classifier and the proposed score of the current classifier are averaged to produce a new score; (4) two very different scores are both replaced with null (indeterminate) in the hopes that a subsequent classifier will provide additional clarity as to the appropriate score; and the like. For example, a first classifier may be configured to exclude web pages that are too large for a second classifier in a chain of classifiers to handle. The first classifier may be configured to set the web page's score to zero if the web page is determined to be too large and a null score if the web page size is determined to be acceptable. The chaining rule may be to “replace null scores only.” The second classifier may then be configured to ignore zero-scored documents as non-null and replace the null values with the appropriate score based on the second classifier's classification criteria.

Embodiments of the sampler module may also include classifier modules arranged to operate in parallel in order to assign multiple scores to a single web page. The sampler module may then use each score separately to provide multiple scores for a website, or the sampler module may be configured to combine one or more of the scores to produce a new score for the web page or the website.

Just as embodiments of the sampler module may use multiple classifier modules linked together in series and/or in parallel to classify individual web pages, embodiments of the website classifying systems may use one or more samplers operating in series and/or in parallel to classify individual websites. If multiple sampler modules are used, the one or more scores of each sampler may be output by the website classifying system separately or the scores of one or more samplers may be combined to output one or more new scores for a website.

### Ranked Link Extraction

The efficiency of the multi-tiered crawler of the present invention depends upon efficiently and accurately classifying collections of web pages, such as websites. To accomplish this, embodiments of the present invention utilize one or more of the sampler modules described above to analyze a limited number of web pages of each website in order to make assumptions about the website based on the analysis of the limited number of web pages. As a result, the efficiency of the crawling system generally also depends upon how many web pages of a website need to be analyzed in order to make accurate assumptions about the website as a whole.

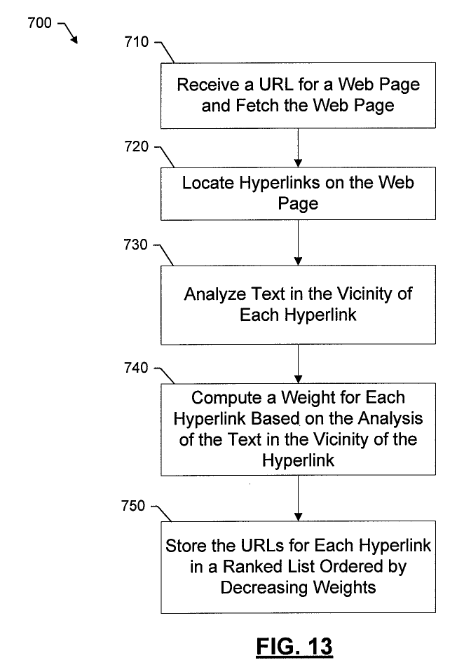

According to one embodiment of the present invention, a ranked link extraction system is provided to allow for accurate assumptions to be made about a website (or other collection of web pages) based on the examination of a relatively small fraction of the pages that may exist on the site. FIG. 13 illustrates the steps that may comprise a ranked link extraction system 700 according to one embodiment of the present invention. The system 700 first receives a URL for a web page and fetches the web page from the network (step 710). The system then locates hyperlinks on the web page (step 720) and analyzes the text in the immediate vicinity of the each hyperlink (step 730). A weight score for each hyperlink is computed based at least partially on the text in the immediate vicinity of the hyperlink (step 740). The hyperlinks are then stored in a ranked list of hyperlinks based on the relative weights of the hyperlinks, generally from a higher weight to a lower weight (step 750).

In one embodiment of the ranked link extraction system 700, the weight for a hyperlink is computed based on how well the text in the immediate vicinity of the hyperlink relates or does not relate to some set of interest. For example, a weight score may be a measure of the strength of the correlation between the text and the type of documents that the crawling system is attempting to find. In some embodiments, the ranked link extraction system 700 is configured to measure the strength of the correlation between the text and set of interest (and appropriately adjust the weight score) using information about the source of the URL for the web page being examined by the system. In other words, if the ranked link extraction system 700 is being used, for example, in a lower tier of a cascading focused crawling system, the historical context of the links or paths that led to the web page currently being examined can influence the weight score of extracted links from that web page. For example, a hyperlink labeled “search” may score average when found on a web page having no historical context, however, the hyperlink may score significantly higher if the link that was used to arrive at the current web page was labeled “real estate” and/or had a high weight score. Similarly, the hyperlink may score significantly lower if the link used to arrive at the current web page was labeled “yellow pages” and/or had a low weight score.

In one embodiment of the system, weight scores may be both positive and negative. For example, weights may be positive when the text indicates the desired document type, and weights may be negative when the text predicts an absence of that document type. The magnitude of the weight may indicate the strength of the positive or negative relation.

For example, in the real estate context, the word “estate” found in close vicinity to a hyperlink may be a poor indication of the likelihood that the link is related to real estate unless the word “estate” is specifically part of the phrase “real estate.” In such a scenario, the word “estate” may be given a weight of −4 and “real estate” may be given a weight of +8. In this way, “estate” without the “real” is a 4-unit penalty but “real estate” is a 4-unit bonus (+8 −4). Naturally, weights assigned to particular terms or phrases of text may vary depending on where in the multi-tiered crawler the ranked link extraction system is used.

In one embodiment of the ranked link extraction system, each hyperlink starts with a baseline weight score and the weights of the text in the vicinity of the hyperlink either add or subtract from this baseline score. In one exemplary embodiment, the baseline score is large enough so that the number of digits in the cumulative weight scores of each of the ranked hyperlinks is the same. Keeping the numbers of digits in each weight score constant may assist in ordering the hyperlinks by their relative weights.

Preferably the text in the vicinity of the hyperlink that is analyzed is text that has a high probability of relating to the contents of the link. For example, the text that is analyzed may be: text from the URL associated with the hyperlink; the link text of the hyperlink in question; text associated with any image files used in the hyperlink; text in the link structure; or text nearby the hyperlink in the HTML code or in the displayed web page. Where text near the hyperlink is used to weight the hyperlink, it may be preferable to not analyze text beyond a punctuation mark in the text following the link. In one embodiment, the system analyzes text within some number of words in front of the link (or up until another link or punctuation mark) to get a more complete context in which to interpret the link.

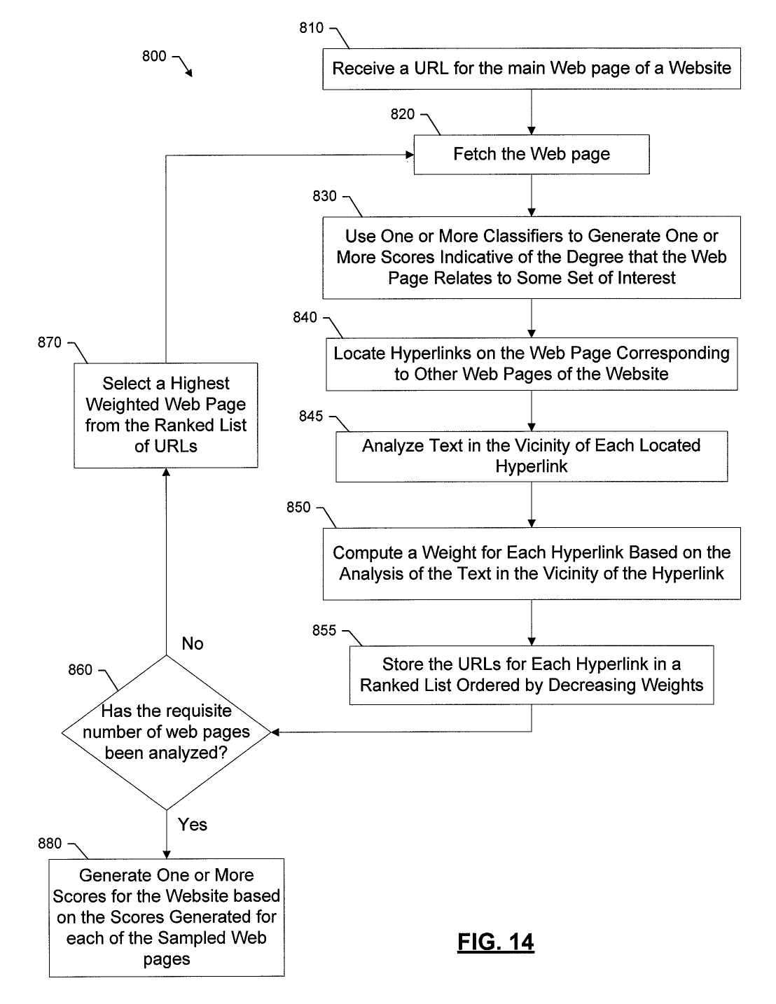

FIG. 14 illustrates an embodiment of a sampler module 800 that has been configured to incorporate one embodiment of the ranked link extraction system. As described above with respect to FIG. 14, the sampler module begins by receiving an indication of a collection of documents, such as a URL for the homepage of a website (step 810). The homepage is then fetched from the network (step 820) and one or more classifiers are used to generate one or more scores indicative of the degree to which the web page relates to one or more sets of interest (step 830). In addition to generating scores for the web page, the sampler module also locates hyperlinks on the web page that correspond to other web pages of the same website that the current web page is a member of (step 840). Using the ranked link extraction system, the sampler then analyzes text in the immediate vicinity of each hyperlink that it locates (step 845) and computes a weight score for each hyperlink based on the text and how the text relates to a set of interest (step 850). The hyperlinks (or the URLs corresponding to the links) are then stored in a datastore and ordered based on the relative weights of the hyperlinks, from higher weights to lower weights (step 855). If the sampler has not yet sampled the required number of web pages of the website, the sampler then selects the link having the highest relative weight from the datastore. The sampler then fetches the web page corresponding to this link and repeats steps 830-855. During step 855, the weighted links discovered in each iteration of the loop are stored in a common datastore. In this way, subsequently discovered links that have a higher weight score relative to an earlier discovered links can displace the earlier discovered links in the ordered list. In other words, if the sampler is configured to analyze ten web pages from a website, the ten highest weighted web pages may change as the sampler goes through ten iterations of the loop.

In one embodiment of the sampler module 800, subsequently discovered links do not displace links that have already been classified by the sampler even if the links already classified have lower weight scores than subsequently discovered links. In such an embodiment, the number of web pages that the sampler classifies may be kept constant, but the average link weight for the web pages that are classified may be increased by the ranked link extraction system. In another embodiment of the sampler module 800, however, subsequently discovered links may displace links that have already been classified by the sampler if the links already classified have lower weight scores.

### Document Crawler and Classifying System

The Document Crawler and Classifying System is generally comprised of a crawler module configured to receive an indication of a collection of documents and exhaustively find and retrieve every available document from the indicated collection of documents. Like the sampler module described above, the document crawler and classifying system uses one or more classifier modules to analyze documents of the collection. Unlike the sampler, however, the document crawler and classifying system is not concerned with classifying the collection and is instead configured to specifically locate the individual documents of a collection that are actually related to the main crawler's topic of interest or a subtopic of interest. In some embodiments of the present invention, the document crawler and classifying system is configured to find documents that contain a specific type of information related to the topic or subtopic of interest.

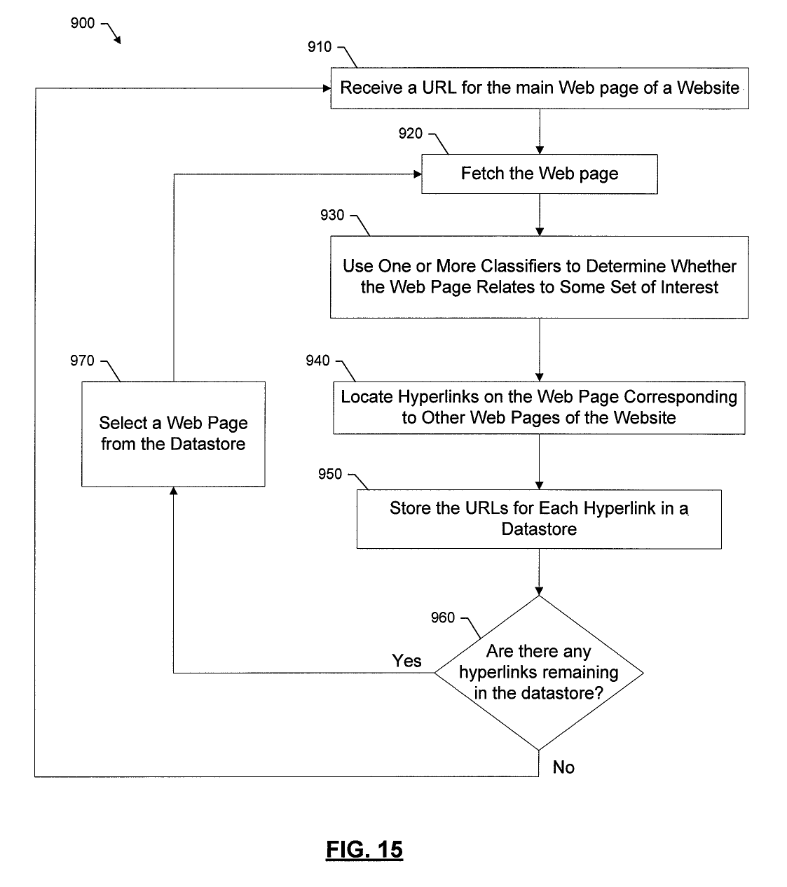

FIG. 15 illustrates an embodiment of a document crawler and classifying system 900 that is configured to operate within the framework of the Web, wherein documents are comprised of web pages and collections of documents are comprised of websites (or some other collection of web pages). The system 900 first receives an indication of a collection of web pages, such as a URL for a website's homepage (step 910). The system 900 fetches a web page of the collection of web pages, such as the website's homepage (step 920), and uses one or more classifiers to analyze the contents of the web page and determine whether the web page relates to some set of interest (step 930). If the web page does relate to some set of interest, the web page or the web page URL may be output into a datastore or to a system capable of using web pages that relate to the set of interest. The system 900 also has a web crawling component for locating the available web pages of a website. In this regard, the system 900 may be configured to locate and record any hyperlinks on each web page that correspond to other web pages of the same website (step 940) and store these other web pages in a datastore (step 950). As described above, the system may also be configured to generate pseudo URLs if the system encounters a form on a web page, and then store the web page corresponding to the pseudo URL in a datastore. The system 900 then selects another web page to analyze from the datastore (step 970) and repeats steps 920-970 until there are no more web pages remaining in the datastore (step 960). When there are no more web pages in the datastore corresponding to that particular website, the system 900 may return to step 910 and receive a web page from another website.

For example, to use the example described earlier of a multi-tiered crawler configured to locate information related to real estate listings, the various tiers coming before the document crawler and classifying system may have narrowed the Internet down to a plurality of websites or website branches that have been determined to at least include one or more web pages related to real estate or some subtopic of real estate, such as new home construction. Thus, the document crawler and classifying system may now be configured to exhaustively crawl each website determined to contain information relevant to new home construction and find all of the individual web pages that actually include listings for the sale of new homes. According to one embodiment of the present invention, the document crawler and classifying system may be configured to output these web pages, or the web page identifiers, to other systems, such as an indexing system that indexes the web pages, or a data extraction system that actually extracts the listing data and compiles the data extracted from each web page into a searchable datastore of real estate listings.

### Cyclic Arrays of Network Hosts and the Document Fetching System

Many of the systems and subsystems described above involve fetching multiple documents from the same host. For example, the document crawler and classifying system 900 generally must repeatedly submit document requests to the same host as it crawls the collection of documents supported by the host device and downloads and analyzes the individual documents in that collection. Likewise the link harvester system 550, the targeted harvester system 580, and the sampler module 600 of the collection classifying system may also have to repeatedly submit document requests to the same host. As described in the background section above, politeness often requires that multiple document requests not be made too rapidly to the same host so that the host's network performance is not significantly degraded or used up by the crawler. As also described above, being “polite” generally requires that a crawling system wait for some period of time after submitting one document request (e.g., an HTTP request for a web page) to a host before submitting another document request to the same host. Naturally, if the crawling system must sit idle, even if for a second, between submitting multiple document requests to the same host, efficiency of the crawling system is not maximized.

In order to satisfy the politeness requirements while maintaining the efficiency of the crawling system, embodiments of the present invention utilize a novel approach for fetching multiple documents from a plurality of hosts. Specifically, the hosts that are to be accessed are organized into one or more groups of hosts. The hosts are arranged in an array having a first host and a last host. Each host includes a list of documents or web pages to be requested from the host. A cyclic array of hosts is created wherein the first host follows after the last host and the last host comes before the first host. One document or web page is requested from each host in the array, one host at a time. After the first request has been submitted to each of the web hosts in the array ending with the last host in the array, a second request can be submitted from each host in the array beginning with the first host again and ending with the last host. This process may then continue spiraling around the cyclic array of hosts and down the list of documents to be requested from each host. If the array of hosts is large enough, the time it takes to make a request to each host in the array is greater than the politeness requirement for any host in the array. In this way, the requesting system may be able to constantly make web page requests while, at the same time, remaining polite to the individual hosts.

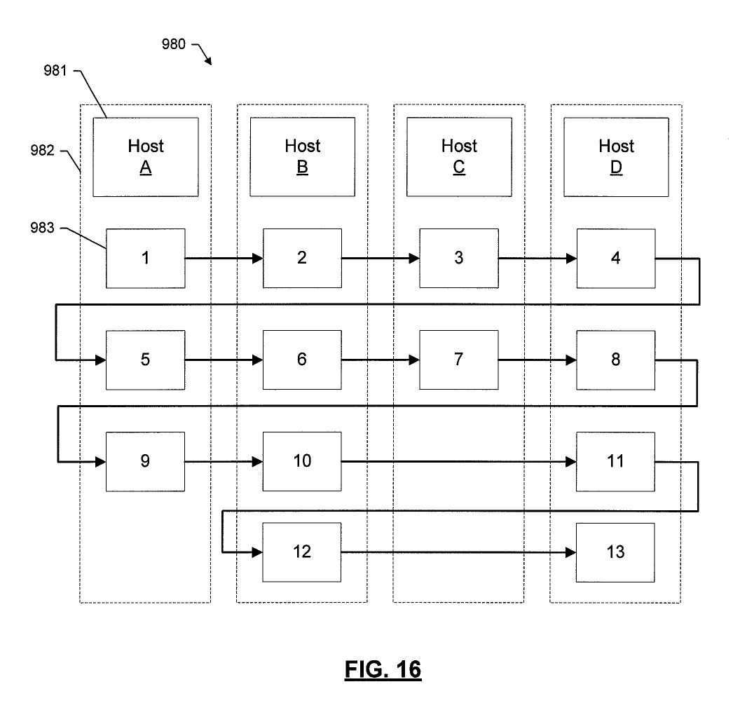

In order to more clearly illustrate the concept of the cyclic array of web hosts, FIG. 16 provides a simplified illustration of one cyclic array 980. Blocks 981 represent web hosts and blocks 983 represent web page requests that are to be made to the web host. FIG. 16 illustrates an array comprised of four hosts A-D. Listed vertically below each host are the web page requests that the crawling system needs to submit that host. The number and the arrows illustrate the order in which the web page requests would be made according to the above-described requesting system. As is depicted by the figure, a first request would be submitted to host A, after which a first request would be submitted to host B, after which as first request would be submitted to host C, after which a first request would be submitted to host D, after which a second request would be submitted to host A, and so on.

The process described above can continue until all of the requests for all of the web hosts have been made. However, since each host in a group may vary with respect to the number of web page requests that are to be made to the host, some hosts may have all of the requests submitted before the other hosts. As hosts run out of requests to be submitted to them, the host is skipped each time its turn arrives. As this happens, the group of hosts may become smaller and smaller. At some point, depending on the size of the group and the time required to be polite to a host, the array of hosts may become small enough to where one trip around the array of hosts does not satisfy the politeness requirement. When this happens, the requesting system may be configured to monitor the time since the last request for each host and, if a request is to be made to a host before the politeness requirement is met, the system may be configured to either wait until the politeness requirement is met to submit the request or to simply skip over the host until the system comes across a host where the politeness requirement is satisfied. Due to the fact that efficiency may be reduced as the array of hosts gets smaller in size, it may be beneficial to attempt to form groups of hosts that have similar sized lists of requests to be made.

In one embodiment, the host may be removed from the group instead of merely being skipped over by the system making the requests. In another embodiment, however, the host is never removed from the group and is simply skipped each time its turn is arrived and the host has no more requests to be submitted to it. Such an embodiment, where the empty host is not removed from the group, may be beneficial since crawling some other host in the system may yield new requests for the “empty” host.

In one embodiment of the present invention, hosts that do not have any requests to be made remaining may be replaced by new hosts to which requests need to submitted. In this embodiment, the host array size may be kept constant or nearly constant so that politeness requirements are generally always met.

Note that in some embodiments of the present invention, the politeness requirements may be constant for all hosts, such as some predetermined amount of time. In other embodiments of the present invention, politeness requirements may be based on the individual host. For example, the time required to be polite to a particular host may depend on how quickly the host responded to the last request that was submitted to the host. If the host took a long time to respond to a request, the time required to be polite may be adjusted to be longer than the time required to be polite to a host that responds immediately after a request is made.

In one embodiment of the invention, the system is configured to “re-crawl” the pages of a host in order to ensure that information is kept relatively fresh. One method of re-crawling involves making the requests of each host of the cyclic array 980 cyclic themselves. In other words, the individual columns illustrated in FIG. 16 are themselves cyclic. For example, after reaching the last request for a host, on the next turn for making a request to that particular host the system may automatically return to the first request for that host and work its way down through the requests of that host again. In one embodiment, each time a request is made to a host, the request is time stamped with a “last crawl” timestamp. When the system progresses through all the requests of a host and attempts to re-crawl a page of the host by making the same request again, the time stamp is checked to determine whether the last crawl is longer than a “re-crawl period” parameter. The re-crawl period may be a parameter set on a host-by-host basis. For example, if the re-crawl parameter is two weeks, then the system progresses through the cyclic array making requests to hosts in the group, but skipping requests that were made less than two weeks ago. Eventually, the time since skipped requests were last made is greater than two weeks old, and the system automatically begins making such requests again, updating the “last crawl” timestamp as it does. In this way, the cyclic array structure may allow for not only the initial accumulation of information from a group of hosts, but also management of the “freshness” of the information.

In one embodiment, a host is skipped if its next request to be made cannot be completed due to a robot exclusion policy, an unsatisfied politeness requirement, or an unsatisfied re-crawl period. In such a case, the next time a request is to be made to that host (i.e., the next time around the cyclic array) the system may proceed to the next request for that host. In another embodiment, the next time around the cyclic array, the system may try again to make the request that was skipped on the last time around the cyclic array.

In one embodiment of the present invention, individual systems or subsystems of the multi-tiered crawler are configured to make requests from a plurality of hosts using the above described cyclic array method. In another embodiment of the present invention, the multi-tiered crawler may comprise a document fetching system configured to make requests for documents on the network for one or more of the systems and subsystems of the multi-tiered crawler. In this embodiment, whenever the one or more systems and subsystems require that a document request be made to a host on the network, the request is first sent to the document fetching system. The document fetching system can then compile the requests from the one or more systems and subsystems and make the requests using the cyclic array process described above. Other advantages of such a centralized requesting system might be that the fetching system could temporarily store requested documents in a cache so that, as the collections are passed from one tier to another, if other tiers in the multi-tiered system need to analyze the same documents, the documents do not have to be requested from the host two or three times in a row.

FIG. 16 illustrates a cyclic method where the system queries each site in a serial order. In some instances, some hosts may have longer wait times than others. It could be possible to time the system so that some hosts are queried more often than others based on individual wait times. For example, in FIG. 16, if Host B has a wait time that is significantly longer than that of the other hosts, the system could be configured to skip Host B in the query cycle and query it, for example every other time. The sequence would look as follows: Host A, Host B, Host C, Host D, Host A, Host C, Host D, Host A, Host B, Host C, Host D, and so on.

### Extraction

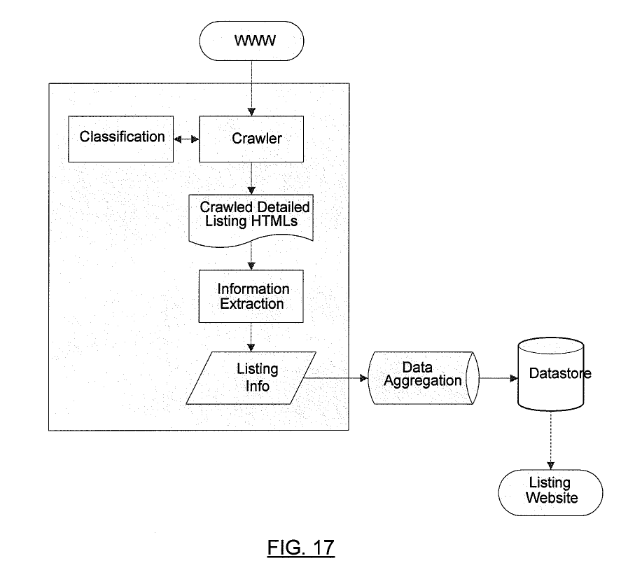

According to an additional embodiment of the present invention, following web crawling and classification of various web pages, websites, or other information of interest, data extraction is employed to extract information of interest and to format the information in a format that is capable of being further processed by various applications. In general, data extraction uses the information identified as relevant from crawling in order to identify specific pieces of data or entities that may be provided in an indexed format for a search engine. For example, with respect to the real estate industry, listing information relating to price, number of bedrooms, etc. can be identified and located on one or more web pages identified during the crawling and classification processes, as shown in FIG. 17. Thus, the extraction process may extract relevant real estate listing information and output the information to a data aggregation process for storage in a datastore such that a listing website or other application is capable of accessing the datastore in response to real estate inquiries from users. As such, a variety of extraneous information identified during the crawling process can be eliminated using the extraction process for more efficient searching by end users for items of interest using a search engine.

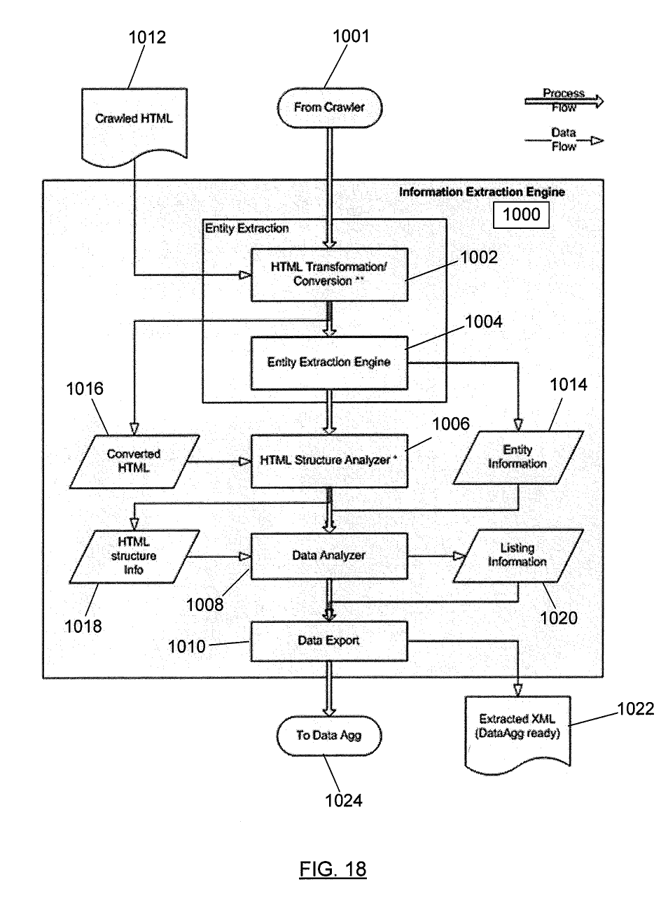

With reference to FIG. 18, there is illustrated a system architecture and a process for extracting various data from information identified during a crawling process according to one embodiment of the present invention. FIG. 18 depicts the process flow and data flow through the information extraction engine 1000. The data from the crawling process generally flows through both the data flow and process flow paths shown in FIG. 18. In general, the process flow of the information extraction engine 1000 from the crawler 1001 includes an HTML transformation/conversion module 1002, an entity extraction engine 1004, an HTML structure analyzer module 1006, a data analyzer module 1008, and a data export module 1010. In addition, the data flow of the information extraction engine 1000 begins as a plurality of HTML documents or web pages obtained from the crawling process and is output as data that are useful and usable for various applications, such as data that are indexible and searchable with a search engine.

Entity extraction generally encompasses both the HTML transformation/conversion module 1002 and the entity extraction engine 1004. The HTML transformation/conversion module 1002 is employed to enhance the extraction process by altering the source of the HTML files and eliminating content within each HTML document that may negatively affect the extraction process, such as with errors or noise. For example, JavaScript could contain data that is not related to the content of the HTML file. In particular, the HTML transformation/conversion module 1002 may be used to remove unwanted HTML tags (e.g., <meta> and <script>) from the HTML documents (block 1016), replace HTML tags with corresponding values (e.g., <br> with a linefeed), and/or keep the structure and font-related tags (e.g., <table> and <font>) within the HTML documents obtained from the crawling process (generally depicted as block 1012). Thus, the HTML transformation/conversion module 1002 modifies the HTML documents into a format that facilitates the extraction of desirable data from the documents. However, the transformation/conversion module 1002 may not be needed for some entity extraction vendors, for example, where a specific entity extraction engine 1004 is capable of processing the current HTML format and ignoring unwanted HTML tags contained in the HTML documents.

The entity extraction engine 1004 is utilized to extract various relevant pieces of data (i.e., entity information depicted as block 1014) from the HTML documents. For instance, with respect to the real estate industry, the entity extraction engine 1004 could extract information relating to the number of bathrooms, the number of bedrooms, or the price of a real estate property.

In some embodiments, the entity extraction engine 1004 extracts not only from the HTML documents itself but also from the metadata associated with the document during the crawling and classification process described above. For example, such metadata may include, among other things, a history of the text in the vicinity of each link that was followed in order to reach the document being processed by the entity extraction engine 1004. The may allow for more complete information extraction since. For example, with regard to a real estate listing, even if no single document has all of the information provided in it, the crawling system can accumulate the missing information along throughout the path that was used to reach the current document and such information may be stored as metadata associated with the current document. For example, with things like the City and State in an addresses, the city and/or the state may be the name of a link that was used to get to a document having details about a property. However, the address in the document might only have the street address and might not mention a city or a state since it is assumed that such is known based on the link used to arrive at the document. By extracting or otherwise using metadata gathered during the crawling process, such omissions in the current document may be handled.

In order to facilitate extraction, the entity extraction engine 1004 could use techniques, such as standardization, to convert information within the HTML documents into a standard format. For example, a real estate listing may include different formats for describing bedroom, such as bdrm, bd, br, brm, etc. The entity extraction engine 1004 recognizes these format differences and ensures that the correct data is extracted from the HTML document. The entity extraction engine 1004 could be supplied or supported by products such as those developed by ClearForest Corporation and Basis Technology Corporation.

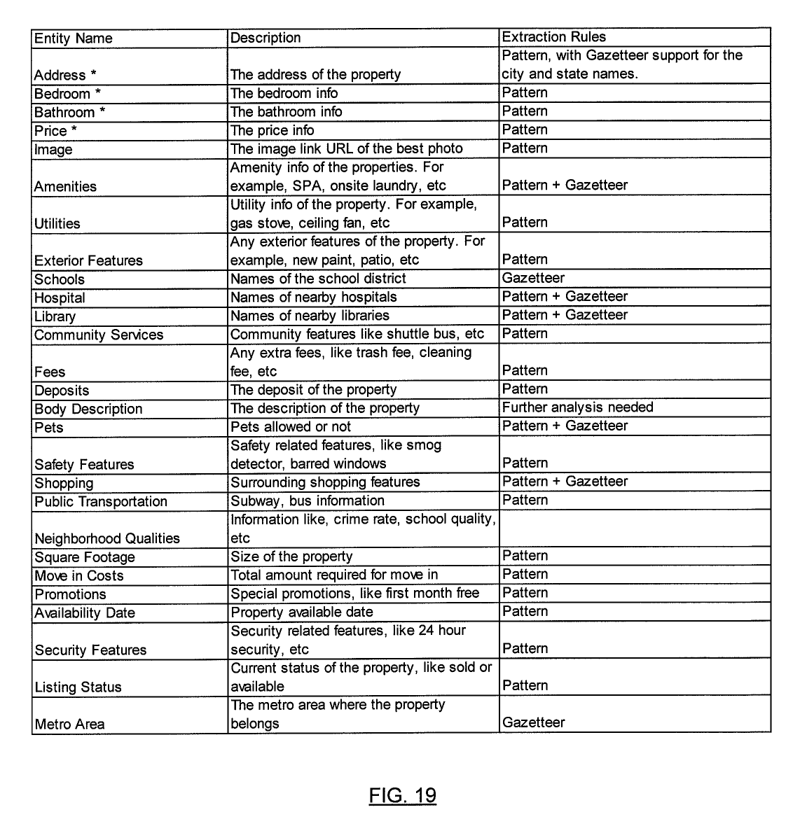

However, rules that facilitate the integration of the data from the crawler with the information extraction 1000 are necessary. Rules are utilized to define the entities of interest contained in the HTML documents. The rules may be pattern rules and/or Gazetteer rules. Thus, pattern rules correspond to a particular entity pattern, while Gazetteer rules correspond to a particular geographical aspect of an entity. With reference to FIG. 19, an exemplary table is shown that depicts various entities and associated extraction rule types. For instance, an entity such as an address includes a description of the address of a specific property, where the pattern rules correspond to the particular house or rental number, street, city, state, and zip code, while the Gazetteer rules correspond to the city and state names.

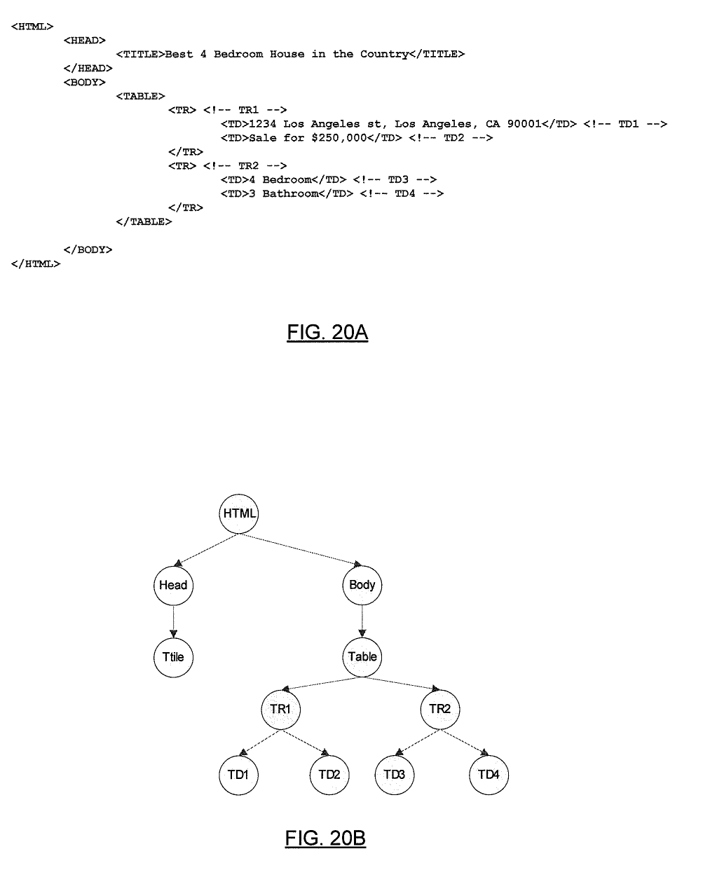

The HTML structure analyzer module 1006 is employed to convert an inputted HTML document into HTML structural information (block 1018), which typically comprises an HTML tree. Depending on the specific entity extraction engine 1004 used, the HTML structure analyzer module 1006 may be located before or after the entity extraction engine in the process flow path due to the fact that some entity extractors require the raw HTML to be transformed prior to extraction. The HTML tree contains HTML nodes that have information required for further processing by the data analyzer module 1008. An HTML node corresponds to an HTML tag in the document, and only tags defined in the desired HTML node set are converted. In particular, the HTML node contains summarized information of an HTML tag. For example, FIG. 20A shows an HTML source, while FIG. 20B shows the corresponding HTML structure with each node including various information. For instance, the HTML node may include various information, such as buffer position, entities found in the tag, CSS info, tag type, tag name, parent node address, child node address, sibling node address, and any other information that could be useful depending on specific requirements. A desired HTML node set contains a list of HTML tags that defines how the HTML structure analyzer module 1006 builds the HTML tree. The HTML structure analyzer module 1006 creates and appends an HTML node to the HTML tree for tags that are defined in the desired HTML node set and ignore HTML tags that are not.

The data analyzer module 1008 is used to analyze the data (i.e., entity information 1014) provided by the entity extraction engine 1004 and the HTML structure information (block 1018) from the HTML structure analyzer module 1006 to identify specific information of interest. For example, after the information extraction process pulls desired information out of various HTML documents, the information from each document could span the entire document and not be associated with each other. An information grouper can combine the individual pieces of information together based on grouping rules and their associated HTML document features so that the information can be more representative and informative. For example if the entity extraction process locates two price entities, two address entities, and two bedroom entities from a real estate listing page, the entity extraction process is unable to determine how the price, address, and bedrooms are associated with each other. Thus, using an intelligent grouper, a set of listing information, such as price, address, amenities, and bedroom, can be identified. Each listing includes details of a plurality of grouped entities, which provides more useful information than the entities alone. After the information grouper combines all the entities into desired groups, the groups are output in a desired format, for example, XML files, that can be used by various processes, such as search engines.

Moreover, the data analyzer module 1008 could analyze various images associated with each HTML document. For example, with respect to the real estate industry, a real estate detail listing page could contain photos associated with the real estate property, as well as many other images such as banners, icons, logos, etc. Given the attributes of the image (e.g., type of file or image size) and the position of the image relative to other real estate entities, desired real estate images can be obtained. Thus, images relating to a particular real estate property can be readily identified so that the images associated with the property listing will be displayed to the user.

The information output and organized by the data analyzer module 1008 is provided to the data export module 1010. The data export module 1010 is responsible for exporting the data in formats for indexing and further processing (block 1022). Namely, the data export module 1010 outputs the extracted data to a data aggregation module 1024 where data from several different sources may be consolidated into one or more datastores. For instance, the data may be output in a ready-XML format, such that the data may be used by many different applications, such as Windows®-based applications, databases, search engines, websites, etc.

According to one aspect of the present invention, the system generally operates under control of a computer program product. The computer program product for performing the methods of embodiments of the present invention includes a computer-readable storage medium, such as the memory device associated with a processing element, and computer-readable program code portions, such as a series of computer instructions, embodied in the computer-readable storage medium.

In this regard, FIGS. 3-18 are control flow diagrams of methods and program products according to the invention. It will be understood that each block or step of the control flow diagrams, and combinations of blocks in the control flow diagrams, can be implemented by computer program instructions. These computer program instructions may be loaded onto a processing element, such as a computer, server, or other programmable apparatus, to produce a machine, such that the instructions which execute on the processing element create means for implementing the functions specified in the block(s) or step(s) of the control flow diagrams. These computer program instructions may also be stored in a computer-readable memory that can direct the processing element to function in a particular manner, such that the instructions stored in the computer-readable memory produce an article of manufacture including instruction means which implement the function specified in the block(s) or step(s) of the control flow diagrams. The computer program instructions may also be loaded onto the processing element to cause a series of operational steps to be performed on the processing element to produce a computer implemented process such that the instructions which execute on the processing element provide steps for implementing the functions specified in the block(s) or step(s) of the control flow diagrams.

Accordingly, blocks or steps of the control flow diagrams support combinations of means for performing the specified functions, combinations of steps for performing the specified functions, and program instruction means for performing the specified functions. It will also be understood that each block or step of the control flow diagrams, and combinations of blocks or steps in the control flow diagrams, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of searching a network for information related to a topic of interest, wherein the network comprises a plurality of documents containing information, and wherein one or more of the documents are grouped together into a collection of documents so that the network comprises a plurality of collections of documents, the method comprising:
exploring the contents of one or more individual documents of a collection of documents;
making a determination of the relevancy of the one or more individual documents of the collection to the topic of interest; and
making a determination of the relevancy of the collection based at least partially on the relevancy of the one or more individual documents in the collection.

2. The method of claim 1, further comprising:
repeating the steps of exploring the contents of one or more documents, making a determination of the relevancy of the one or more documents, and making a determination of the relevancy of the collection, for a plurality of the collections on the network.

3. The method of claim 2, further comprising:
exploring the contents of every available document in a collection if the determined relevancy of the collection is greater than a threshold relevancy.

4. The method of claim 1, wherein the network is the Internet, wherein each document comprises a web page, and wherein each collection of documents comprises a collection of web pages.

5. The method of claim 4, wherein each collection of web pages comprises web pages from a common website or a common branch of a website.

6. The method of claim 4, wherein the network comprises a plurality of hosts that make one or more web pages available on the network, and wherein each collection of web pages comprises web pages from a common host.

7. The method of claim 1, further comprising:
locating one or more collections of documents on the network.

8. The method of claim 7, wherein the network comprises the Internet, wherein the documents comprise web pages, wherein the collections of documents comprise websites, and wherein the step of locating one or more collections on the network comprises:
providing a list of one or more web page URLs;
exploring one or more web pages using URLs from the list; and
recording any website URLs found on the one or more web pages being explored.

9. The method of claim 8, further comprising:
recording any web page URLs found on the one or more web pages being explored;
adding the recorded web page URLs to the list of one or more URLs; and
repeating the steps of exploring one or more web pages from the list, recording any website URLs, recording any web page URLs, and adding the web page URLs to the list.

10. The method of claim 8, further comprising:
generating URLs to simulate entering information into a form found on the one or more web pages being explored;
adding the generated URLs to the list of one or more URLs;

11. The method of claim 1, further comprising:
providing a plurality categories related to a plurality of sub topics of the topic of interest;
exploring the contents of one or more of the documents of the collection if the determined relevancy of the collection is greater than a threshold relevancy; and
placing at least some of the collections of documents into one or more of the categories based at least partially on the contents of the one or more documents being explored.

12. The method of claim 11, further comprising:
searching one or more documents of a collection that has been placed into a category for a predetermined type of information related to the topic or subtopic, wherein the search and/or the type of information searched for is based at least partially on the category in which the collection has been placed.

13. The method of claim 12, further comprising:
extracting the predetermined type of information from the documents that contain the predetermined type of information.

14. The method of claim 12, wherein the topic of interest comprises real estate, and wherein the predetermined type of information comprises information related to the real estate sale or rental listings.

15. The method of claim 3, further comprising:
searching one or more documents of a collection for a predetermined type of information related to the topic or subtopic, if the determined relevancy of the collection is greater than a threshold relevancy; and
extracting the predetermined type of information from the documents that contain the predetermined type of information.

16. A system for gathering information related to at least one topic of interest, the system comprising:
a multi-tiered system configured for searching a network for information related to at least one topic of interest, wherein each tier comprises more restrictive criteria than the previous tier for locating the at least one topic of interest.

17. The system of claim 16, wherein the network comprises a plurality of collections of documents, each collection comprising one or more documents, the multi-tiered system comprising:
a first tier configured to obtain a list of collections of documents on the network;
a second tier configured to classify each of the collections in the list as being a member of one or more of a plurality of categories; and
a third tier configured to examine the documents of at least some of the collections based at least partially on the classification of collections by the second tier.

18. The system of claim 17, wherein the first tier is configured to search the network to locate collections of documents.

19. The system of claim 17, wherein the plurality of categories comprises a category for collections considered to be relevant to the one or more topics of interest and a category for collections considered to be irrelevant to the one or more topics of interest.

20. The system of claim 17, wherein the plurality of categories comprises one or more categories based on language or dialect.

21. The system of claim 17, wherein the one or more topics of interest comprise subtopics of interest related to the one or more topics of interest, and wherein the plurality of categories comprises one or more categories related to the one or more subtopics of interest.

22. The system of claim 17, wherein the second tier comprises a plurality of tiers each tier comprising more restrictive criteria for classify each of the collections in the list as being a member of one or more of a plurality of categories.

23. The system of claim 17, wherein the second tier comprises a sampler module for examining one or more documents in each collection in order to classify the collection as being a member of one or more of a plurality of categories.

24. The system of claim 23, wherein the sampler module comprises a crawler system for locating the one or more documents in each collection that are used to classify the collection.

25. The system of claim 24, wherein the network comprises the Internet, wherein the documents comprise web pages, wherein the crawler system comprises a web crawler system, wherein the web crawler system is configured to locate the one or more documents of a collection by searching one or more documents in the collection for links in the text of the document that provide access to other documents in the collection, and wherein the web crawler system is configured assign a rank to the documents that it locates based on text in the immediate vicinity of the links related to those documents, and wherein the sampler chooses one or more documents to examine based on the rank of the document.

26. The system of claim 23, wherein the sampler module is configured to classify the collection by examining a plurality of documents of the collection and assigning a score to each document based on the relevancy of the document to one or more of the plurality of categories.

27. The system of claim 23, wherein the one or more documents of a collection used by the sampler module to classify the collection comprise less than all of the documents of the collection.

28. The system of claim 17, wherein the network comprises the Internet, and wherein the documents comprise web pages, the third tier further comprising a web crawler for locating the documents of a collection.

29. The system of claim 17, wherein the third tier is further configured to examine the documents of a collection to determine whether each document of the collection relates to the at least one topic of interest.

30. The system of claim 29, wherein the third tier is further configured to examine the documents of a collection to determine whether each document of the collection comprises a particular type of information related to the at least one topic of interest, and wherein the system further comprises a fourth tier for extracting the particular type of information from each document that the third tier determines comprises the information.

31. A method for requesting web pages from a plurality of web hosts, each web host supporting a finite number of web pages, the method comprising:
grouping the plurality of web hosts into one or more arrays of web hosts, each array comprising a finite number of web hosts; and
submitting a first web page request to each web host in an array before submitting a second web page request to any web host in the array.

32. The method of claim 31, wherein the hosts in the array are ordered from a first web host to a last web host, and wherein the array comprises a cyclic array so that the first host follows the last host in the array, the method further comprising:
submitting a web page request to each web host in the array in order, beginning with the first web host and ending with the last web host; and,
after a web page request is submitted to the last web host, submitting another web page request to each web host remaining in the array in the same order, beginning with the first web host and ending with the last web host.

33. The method of claim 32, wherein submitting another web page request to each host in the same order is repeated until all of the web pages of all of the hosts of the group have been requested.

34. The method of claim 32, wherein the time between submitting a first web page request to one web host and submitting another web page request to the same web host is greater than or equal to the time required to be polite to the web host.

35. The method of claim 33, wherein submitting another web page request to each host in the same order is repeated until all of the web pages of one of the hosts of the group have been requested, and wherein the method further comprises:
replacing the host that has had all of the web pages requested with another host supporting a finite number of web pages to be requested.

36. The method of claim 31, wherein the plurality of web hosts are grouped into one or more arrays based on the number of web pages to be requested to each web host, so that each array of web hosts comprises web hosts having a similar amount web pages to be requested.

37. A method of ranking hyperlinks found on the Internet during a web crawling scheme, the method comprising:
analyzing text in the immediate vicinity of a hyperlink as the hyperlink is found;
computing a weight for that hyperlink based on the relevancy of the text to a set of interest; and
storing the hyperlink in a datastore where hyperlinks stored therein are ranked based on the relative computed weights of each hyperlink.

38. The method of claim 37, wherein the text has a positive effect on the computed weight of a hyperlink if the text is considered to provide an indication that the hyperlink will likely relate to the set of interest.

39. The method of claim 37, wherein the text has a negative effect on the computed weight of the hyperlink if the text is considered to provide an indication that the hyperlink will likely not relate to the set of interest.

40. The method of claim 37, wherein the hyperlink was found in a web page document, wherein the web page document was found on the Internet by accessing one or more links in other web pages, and wherein computing the weight for the hyperlink is further based on information obtained from the one or more links or web pages through which the web page document was found.

41. A system for ranking hyperlinks found in a document on the Internet, the system comprising:
a link weighting system for analyzing text in the immediate vicinity of a hyperlink and for computing a weight for the hyperlink based on the relevancy of the text to a set of interest; and
a datastore for storing the hyperlink with other hyperlinks in a ranked list based on the relative computed weights of each hyperlink.

42. The system of claim 41, wherein the link weighting system is configured so that the analyzed text has a positive effect on the computed weight of a hyperlink if the link weighting system considers the text to provide an indication that the hyperlink will likely relate to the set of interest.

43. The system of claim 41, wherein the link weighting system is configured so that the analyzed text has a negative effect on the computed weight of the hyperlink if the link weighting system considers the text to provide an indication that the hyperlink will likely not relate to the set of interest.

44. The system of claim 41, wherein the text in the immediate vicinity of the hyperlink comprises text from the URL associated with the hyperlink.

45. The system of claim 41, wherein the text in the immediate vicinity of the hyperlink comprises text from the hyperlink.

46. The system of claim 41, wherein the text in the immediate vicinity of the hyperlink comprises text surrounding the hyperlink but between punctuation marks located on either side of the hyperlink.

47. The system of claim 41, wherein the text in the immediate vicinity of the hyperlink comprises text located within a particular number of words coming before the hyperlink in the document.

48. The system of claim 41, wherein the document was obtained on the Internet by accessing one or more links in other web pages, and the link weighting system computes the weight for the hyperlink also based on information obtained from the one or more links or web pages through which the document was obtained.

49. A method of determining whether a collection of web pages relates to a topic of interest, the method comprising:
exploring a web page of the collection of web pages;
determining the relevancy of the web page to the particular topic of interest; and
making a determination of the relevancy of the entire collection of web pages to the topic of interest based at least partially on the determined relevancy of the web page.

50. The method of claim 49, further comprising:
searching the web page for one or more links to other web pages of the same collection of web pages;
storing the one or more links to other web pages of the same collection in a datastore;
selecting a link to a web page from the datastore;
exploring the selected web page;
determining the relevancy of the selected web page to the particular topic of interest;
searching the selected web page for one or more links to other web pages of the same collection of web pages;
storing the one or more links to other web pages of the same collection in the datastore; and
repeating the steps of selecting, storing, exploring, determining, searching, and storing until the number of web pages explored is equal to some predetermined number of web pages less than the total number of web pages in the collection,
wherein the step of making a determination of the relevancy of the entire collection of web pages to the topic of interest comprises basing the determination of the relevancy of the collection based on the determined relevancy of the explored web pages.

51. The method of claim 50, wherein the steps of searching a web page for one or more links to other web pages further comprises:
for each link found on the web page, analyzing the text in the immediate vicinity of the link, and making a determination of the likelihood that the linked web page will relate to the topic of interest based on the analysis of the text in the immediate vicinity of the link;
wherein the steps of storing the one or more links comprises storing the links in order based on the likelihood that each linked web page will relate to the topic of interest; and
wherein the step of selecting a link from the datastore comprises selecting the link in the datastore that has the greatest likelihood of relating to the topic of interest but has not been selected yet.

52. A system of using a web crawler to classify a collection of web pages, the system comprising:
a web crawler module configured to search a web page from the collection for links to other web pages in the collection, and further configured to request web pages corresponding to the link that the web crawler finds and to examine such web pages for more links to other web pages in the collection;
a classifier module configured to make a determination of the relevancy of each web page that the web crawler examines to a set of interest; and
a collection classifying system for making a determination of the relevancy of the collection to the set of interest based on the determined relevancy of the web pages that the web crawler examines.

53. The system of claim 52, wherein the web crawler is configured to examine some number of web pages in the collection less than all of the web pages in the collection.

54. A method of gathering information related to a particular topic of interest, the method comprising:
searching a network for information related to at least one topic of interest, wherein searching the network comprises searching the network in a multi-tiered format such that each tier comprises more restrictive criteria for locating the at least one topic of interest than a previous tier; and
extracting data from the searched information relating to the at least one topic of interest searched on the network.

55. The method of claim 54, wherein searching comprises searching a plurality of websites to find information on the Internet related to a particular topic of interest, wherein each website comprises a plurality of web pages.

56. The method of claim 55, further comprising harvesting a plurality of websites to determine a plurality of websites for searching for information on the Internet related to a particular topic of interest.

57. The method of claim 55, further comprising converting each of the plurality of web pages into a HTML tree prior to, or subsequent to, extracting data from the searched information.

58. The method of claim 54, further comprising altering a format of the searched information prior to extracting data from the information.

59. The method of claim 54, further comprising grouping a plurality of entities of extracted data based on at least one grouping rule.

60. The method of claim 54, wherein extracting comprises extracting at least one image relating to the at least one topic of interest searched on the network.

61. The method of claim 54, wherein searching comprises searching in a multi-tiered format with a plurality of crawlers.

62. The method of claim 61, wherein each of the crawlers comprises at least one classifier to determine the relevancy of the searched information.

63. The method of claim 54, wherein searching comprises searching for information relating to a plurality of real estate listings.

64. The method of claim 63, wherein extracting comprises extracting at least one of price, number of bedrooms, number of bathrooms, address, and amenities from each real estate listing.

65. The method of claim 54, further comprising indexing the extracted data for searching with a search engine.

66. The method of claim 54, wherein extracting comprises extracting data from the searched information using a plurality of extraction rules.

67. The method of claim 54, further comprising outputting the extracted information in a standard XML format.

68. A system for gathering information related to a particular topic of interest, the system comprising:
a multi-tiered system configured for searching a network for information related to at least one topic of interest, wherein each tier comprises more restrictive criteria for locating the at least one topic of interest than a previous tier; and
an information extraction engine configured for extracting data from the searched information relating to the at least one topic of interest searched on the network.

69. The system of claim 68, wherein the multi-tiered system is configured for searching a plurality of websites to find information on the Internet related to a particular topic of interest, and wherein each website comprises a plurality of web pages.

70. The system of claim 69, further comprising at least one harvester configured for harvesting a plurality of websites to determine a plurality of websites for searching for information on the Internet related to a particular topic of interest.

71. The system of claim 69, wherein the information extraction engine comprises a HTML structure analyzer module configured for converting each of the plurality of web pages into a HTML tree prior to, or subsequent to, extracting data from the searched information.

72. The system of claim 68, wherein the information extraction engine comprises a transformation module configured for altering a format of the searched information prior to extracting data from the information.

73. The system of claim 68, wherein the information extraction engine comprises a data analyzer module configured for grouping a plurality of entities of extracted data based on at least one grouping rule.

74. The system of claim 68, wherein the information extraction engine comprises a data analyzer module configured for extracting at least one image relating to the at least one topic of interest searched on the network.

75. The system of claim 68, wherein each tier of the multi-tiered system comprises a plurality of crawlers.

76. The system of claim 75, wherein each of the crawlers comprises at least one classifier to determine the relevancy of the searched information.

77. The system of claim 68, wherein the multi-tiered system is configured for searching for information relating to a plurality of real estate listings.

78. The system of claim 77, wherein the information extraction engine comprises an entity extraction module configured for extracting at least one of price, number of bedrooms, number of bathrooms, address, and amenities from each real estate listing.

79. The system of claim 68, wherein the information extraction engine comprises a data export module configured for outputting the extracted information in a standard XML format.

80. The system of claim 68, wherein the information extraction engine comprises an entity extraction module configured for extracting data from the searched information using a plurality of extraction rules.
